(19) United States
(12) Patent Application Publication
(10) Pub. No.: US 2013/0159174 A1
(43) Pub. Date: Jun. 20, 2013

(54) SYSTEMS, METHODS, AND APPARATUS FOR ENHANCING AND UTILIZING OWED-VALUE ACCOUNTS

(71) Applicant: WALKER DIGITAL, LLC, Stamford, CT (US)

(72) Inventors: Jay S. Walker, Ridgefield, CT (US); Jeffrey Y. Hayashida, San Francisco, CA (US); Stephen C. Tulley, Monroe, CT (US); Russell P. Sammon, San Francisco, CA (US); Zachary T. Smith, Norwalk, CT (US); Renny S. Talianchich, San Francisco, CA (US)

(73) Assignee: WALKER DIGITAL, LLC, Stamford, CT (US)

(21) Appl. No.: 13/735,010

(22) Filed: Jan. 6, 2013

Related U.S. Application Data
(63) Continuation of application No. 12/423,385, filed on Apr. 14, 2009, now abandoned.
(60) Provisional application No. 61/045,082, filed on Apr. 15, 2008.

(51) Int. Cl. G06Q 40/02

(52) U.S. Cl. CPC G06Q 40/02
USPC 705/39; 705/35

(57) ABSTRACT

Systems, methods, and apparatus for enhancing and utilizing owed-value accounts are provided, including, in accordance with some embodiments, automatically utilizing the remaining balance of an owed-value account to purchase a product or service on behalf of the owner of the owed-value account.

### CROSS-REFERENCE TO RELATED APPLICATIONS

This application is a continuation of U.S. patent application Ser. No. 12/423,385 filed Apr. 14, 2009, entitled “SYSTEMS, METHODS, AND APPARATUS FOR ENHANCING AND UTILIZING OWED-VALUE ACCOUNTS”, which claims priority and benefit under 35 U.S.C. §119(e) to U.S. Provisional Patent Application No. 61/045,082 entitled “SYSTEMS AND METHODS FOR PROVIDING LOTTERY ENTRIES FOR CALLING CARDS” filed Apr. 15, 2008. The entirety of each application is hereby incorporated by reference herein.

### BACKGROUND

Of the eighty billion dollars ($80 billion) spent on gift cards in 2006, it is estimated that eight billion dollars ($8 billion) of that will never be spent on purchases. Consumer Reports® estimates that roughly nineteen percent (19%) of gift cards received in 2005 were never used. Also in 2005, Home Depot® reported fifty-three million dollars ($53 million) in revenue due to gift card “breakage”, otherwise known as gift card balances that are fully paid for, but never redeemed.

In response to merchants profiting from gift card breakage, some states have introduced toughened escheat laws which govern how abandoned property is handled. In most situations, California prohibits expiration dates on any gift card or gift certificate valued over five dollars ($5). In addition, California law allows for cash-back to a customer, once their gift card balance drops below ten dollars ($10).

Proceeds from lost cards, cards that are never redeemed, or cards with remaining balances are sometimes turned over to a government authority as required by local escheat laws. The government authority may make several attempts to find the rightful owners of the abandoned funds, but ultimately may end up keeping a majority of the funds.

In addition to consumers wanting to receive the full value of their gift cards, many corporations want gift card balances off their books, since these balances appear as liabilities in financial statements. To combat growing gift card balances on their books, some corporations have instituted maintenance fees which automatically deduct a fee from the gift card balance at a regular interval. Fees continue to be deducted until the balance of a given card reaches zero dollars ($0) and the liability can essentially be written off. Other companies may allow cash back on any value gift card, but in many cases charge a one-time redemption fee to the card-holder. For instance, Wachovia® will allow cash back on any of their Visa® Gift Cards, but charges a fifteen dollar ($15) fee for the transaction.

### BRIEF DESCRIPTION OF THE DRAWINGS

An understanding of embodiments described herein and many of the attendant advantages thereof may be readily obtained by reference to the following detailed description when considered with the accompanying drawings, wherein:

FIG. 1 is a diagram of a system according to some embodiments;

FIG. 2 is a flowchart of a method according to some embodiments;

FIG. 3 is a flowchart of a method according to some embodiments;

FIG. 4 is a flowchart of a method according to some embodiments;

FIG. 5 is a diagram of a database according to some embodiments;

FIG. 6 is a flowchart of a method according to some embodiments;

FIG. 7 is a flowchart of a method according to some embodiments;

FIG. 8 is a diagram of a database according to some embodiments;

FIG. 9 is a diagram of an exemplary owed-value card to some embodiments;

FIG. 10 is a block diagram of a specific machine according to some embodiments; and

FIG. 11 is a block diagram of a system according to some embodiments.

### DETAILED DESCRIPTION

### Introduction

Applicants have recognized that, in some situations, it may be advantageous to utilize balances of owed-value accounts to obtain various products and/or services for the owner of the owed-value account. In some embodiments, for example, Applicants have realized that it may be advantageous to convert balances of owed-value accounts (such as “breakage” balances, as defined herein) into lottery entries and/or fractional lottery entries. According to some embodiments, Applicants have realized that it may be beneficial, upon an owed-value account obtaining a certain status (e.g., a “breakage” status), to automatically utilize the remaining balance of the owed-value account to purchase a product or service on behalf of the owner of the owed-value account. Applicants have also realized that it may be advantageous to consolidate balances of owed-value accounts into a single owed-value account.

Some embodiments, for example, include (i) determining a pre-paid account established with a business entity, the pre-paid account being owned by a customer. Such embodiments may further include (ii) determining a balance of the pre-paid account established with the business entity, (iii) receiving, from the customer, an indication of a lottery to which the customer desires the balance of the pre-paid account to be transferred, (iv) obtaining, in exchange for the balance of the pre-paid account, a transfer amount, (v) utilizing at least one portion of the transfer amount to purchase a lottery account with the lottery, and/or (vi) providing a physical indicia of the lottery account to the customer.

Some embodiments include (i) determining a pre-paid account owned by a customer, (ii) determining a conversion condition assigned to the pre-paid account, wherein the conversion condition specifies a condition upon which a balance of the pre-paid account will automatically be utilized to purchase a product, (iii) determining whether the conversion condition is satisfied, and/or (iv) automatically purchasing, utilizing the balance of the pre-paid account, and in the case that the conversion condition is satisfied, the product for the customer.

Some embodiments include (i) determining a criteria that defines when a pre-paid account balance is considered breakage, (ii) searching a database of pre-paid accounts, (iii) identifying, based on the searching, an account for which the breakage criteria is satisfied, (iv) utilizing a breakage balance of the identified account to automatically purchase a product, and (v) providing an indication of the purchased product to an entity associated with the account.

In one exemplary application of some embodiments, for illustration, a calling card may be purchased by a customer for forty dollars ($40). The customer may then utilize a majority of the balance associated with the calling card, but leave a remaining unused balance of five dollars ($5) on the card. After a year, an expiration condition associated with the calling card may then be triggered (i.e., a one year inactivity trigger), and it may be accordingly determined that the customer may be entitled to a five dollar ($5) lottery entry in return for the five dollar ($5) “breakage” associated with the calling card. In the case that the customer provided an e-mail address (e.g., during the purchase of the calling card), the customer may then be sent a message containing a redemption number associated with a lottery entry. The customer may then, for example, redeem the lottery entry by providing the redemption number and a valid ID to a lottery retailer.

### I. TERMS AND DEFINITIONS

Throughout the description that follows and unless otherwise specified, the following terms may include and/or encompass the example meanings provided in this section. These terms and illustrative example meanings are provided to clarify the language selected to describe embodiments both in the specification and in the appended claims, and accordingly, are not intended to be limiting.

Some embodiments herein are associated with an “Owed-Value Account (OVA)”. As used herein, the terms “owed-value account” and “OVA” may refer to any account which tracks a redeemable balance owed to one or more individuals. An OVA may be prefunded such as in the case of a gift certificate, calling card, or bank account, and/or may accrue based on one or more reward factors (e.g., frequent flyer and/or frequent shopper cards). The redeemable balance in the account may represent a monetary value or other form, which may have cash equivalence. Examples of OVA's include, but are not limited to: (i) long distance and/or other calling cards (e.g., the balance may be stored as cash remaining and/or telephone minutes remaining); (ii) gift certificates and/or gift cards (e.g., the balance may be stored as a cash amount usable towards a purchase at one or more merchants); (iii) rewards program points (e.g., including, but not limited to, airline miles, casino comp points, hotel loyalty points and/or online loyalty programs such as World of Warcraft reward points); (iv) bank accounts (e.g., the balance of a bank account); (v) virtual currencies (e.g., an electronically traded currency that does not issue legal tender bearer instruments—such as Second Life's “Linden Dollar” and Tencent's “QQ”); and/or (vi) mobile phone minutes (e.g., including accrued “rollover” minutes which a customer may use at anytime).

Some embodiments herein are associated with an “Owed-Value (OV)”. As used herein, the terms “owed-value” and “OV” may refer to any balance and/or amount that may be owed to one or more specific parties. An indication of an OV may be stored using various methods known in the art. For example, an indication of an OV may be stored within an OVA, on a magnetic strip (e.g., on a portable physical media such as a card and/or keyfob), and/or in a database.

Some embodiments herein are associated with an “Owed-Value Card (OVC)”. As used herein, the terms “owed-value card” and “OVC” may refer to any physical indicia of an OVA, such as may be embodied in a gift card, a calling card, a credit card, a dongle, a keyfob, etc. The balance of an OVA may be stored in a database on a computer server and identified by an account number or other identifier. This account number or other identifier may be stored on an OVC (e.g., encoded in a magnetic stripe and/or printed, etched, and/or otherwise encoded thereupon). In some situations, the balance of the OVA may be stored on the OVC itself (e.g., on a tamper-proof smart card). In some situations, the balance of an OVA may simply be printed on an OVC (e.g., in the case of a gift certificate). In yet another example, an indication of an OV may be stored in a non-volatile memory device such as a USB key. In some situations, an OVA may not have an associated owed-value card (e.g., for an online account, rewards program points, or mobile phone minutes).

Some embodiments herein are associated with a “purchaser”. As used herein, the term “purchaser” may refer to any party and/or entity that provides consideration in exchange for an OV. For example, a purchaser may provide cash to a merchant in exchange for a gift card. In another example, a purchaser may buy frequent flier miles for a friend.

Some embodiments herein are associated with a “recipient”. As used herein, the term “recipient” may refer to any party and/or entity that receives the benefit of an OV. In some instances, the purchaser and the recipient may be the same party (e.g., when a purchaser buys a calling card for their own personal use, they are also a recipient of the OV). Other examples include: (1) a recipient may receive a fifty dollar ($50) gift card from a purchaser for the recipient's birthday and (2) a recipient may receive five hundred (500) airline miles in return for spending five hundred dollars ($500) on an airline rewards credit card.

Some embodiments herein are associated with a “beneficiary”. As used herein, the term “beneficiary” may refer to any party and/or entity designated to receive a benefit in the case that an OVA is liquidated (e.g., upon “breakage”). A beneficiary may, for example, be designated to receive a lottery entry obtained via OV breakage. A beneficiary may be designated by a purchaser, recipient, and/or third-party associated with an OVA. In some embodiments, the beneficiary may be the recipient and/or the purchaser. For example, a purchaser who buys a discounted gift card for himself and intends to benefit from any expired OV associated with the card may be considered to be the purchaser, recipient, and beneficiary.

Some embodiments herein are associated with a “player”. As used herein, the term “player” may refer to any party and/or entity that is a participant in a game of chance such as a lottery or casino wagering game.

Some embodiments herein are associated with a “merchant”. As used herein, the term “merchant” may refer to any party and/or entity that comprises a business and/or storefront that engages in consumer trade. Merchants may sell gift cards or other indicators and/or OVC's associated with OVA's.

Some embodiments herein are associated with “breakage”. As used herein, the term “breakage” may refer to any balance associated with an OVA that has not been redeemed by the one or more individuals associated with the OVA. As used herein, breakage may be considered an expired OV that may be redeemed for various products and/or services such as one or more entries into a game of chance and/or one or more retail products (e.g., purchased from a merchant). Breakage may stem from and/or be associated with, but is not limited to the following: (i) an expiration condition being reached causing an individual to be ineligible to redeem all or part of an OV associated with an OVA (e.g., an gift certificate that expires one year from date of purchase); and/or (ii) a lost indication of an OVA causing an individual to be unable to redeem a balance associated with an OVA (e.g., if a customer loses a gift card or a PIN number associated with a calling card, the customer may call a phone number to indicate that that it has been lost and the remaining balance of the OVA should be considered breakage).

Some embodiments herein are associated with “float”. As used herein, the term “float” may refer to any balance associated with an OVA that is owed to and/or may be redeemed by one or more individuals associated with the OVA.

Some embodiments herein are associated with a “lottery entry”. As used herein, the term “lottery entry” may refer to any entry into a lottery or other game of chance. As used herein, the phrases “lottery entry” and “entry into a game of chance”, shall be synonymous. Some embodiments herein are associated with a “lottery voucher”. As used herein, the term “lottery voucher” may refer to any coupon, voucher, and/or other identifier (e.g., serial number, barcode, keyword) that may be exchanged for a lottery entry. In some cases, a lottery voucher may need to be redeemed in combination with at least one other form of consideration in order to be exchanged for a lottery entry (e.g., a beneficiary may redeem a fifty-nine cent ($0.59) lottery voucher along with forty-one cents ($0.41) in cash and receive one (1), one dollar ($1.00) lottery entry in exchange). According to some embodiments, a lottery voucher may be paid for with breakage associated with an OVA. In the case that the voucher has been fully-paid, proceeds from unredeemed lottery vouchers may be retained by a lottery authority.

Some embodiments herein are associated with a “lottery outcome”. As used herein, the term “lottery outcome” may refer to any outcome resulting from a game of chance (e.g., lottery, sweepstakes, raffle, casino and/or other wagering game). A lottery outcome may involve choosing one or more winners by randomly selecting from a set of entries, and/or may be of the instant win type (e.g., Massachusetts State Lottery's Fabulous Fortune instant game ticket). A winning lottery outcome may also be associated with matching one or more indicia with a set of randomly generated indicia.

Some embodiments herein are associated with a “lottery authority”. As used herein, the term “lottery authority” may refer to any entity responsible for the operation and oversight of various lottery hardware, software, data and/or systems as described herein. In some embodiments, the lottery authority may comprise an entity that is responsible for primary and/or substantial control of a lottery system.

Some embodiments herein are associated with a “lottery retailer”. As used herein, the term “lottery retailer” may refer to any business, entity, and/or location at which one or more of the following may take place: (i) a beneficiary may register for a lottery outcome; (ii) a new lottery ticket may be purchased; (iii) a voucher/coupon for a lottery entry may be redeemed; and/or (iv) a winning lottery ticket may be verified and redeemed for an eligible prize. Some lottery retailers may not provide all of these services, and it is possible that different lottery retailers may be used for different steps. Examples of a lottery retailer may include, but are not limited to: convenience stores, gas stations, and supermarkets.

Some embodiments herein are associated with a “processing fee”. As used herein, the term “processing fee” may refer to any fee that may be collected to support one or more underlying processes involved in exchanging OV for a lottery entry and/or other good or service. A processing fee may be collected by a lottery authority, a lottery retailer, a merchant, or a third-party in order to maintain additional hardware and software associated one or more embodiments described herein. For example a processing fee may go towards a server and software used to manage an OVA database. A processing fee may also or alternatively be used to pay for shipping/printing costs associated with shipping a physical lottery entry or voucher to a beneficiary. A processing fee may be used to pay for additional support staff needed by a lottery authority, merchant, or other third-party to implement one or more embodiments described herein. In some embodiments, the processing fee may comprise a fee collected in exchange for other OVA services, such as for consolidating multiple OVA accounts onto a single OVC (as described herein).

Some embodiments described herein are associated with an “input device”. As used herein, the term “input device” may generally refer to any device that is used to receive or process input. An input device may communicate with and/or be part of another device. Some examples of input devices include, but are not limited to: a button, a key, one or more softkeys and/or variable function input devices, a bar-code scanner, a magnetic stripe reader, a computer keyboard, a pointing device (e.g., a computer mouse, touchpad, and/or trackball), a point-of-sale terminal keypad, a touch-screen, a microphone, an infrared sensor, a sonic ranger, a computer port, a video camera, a motion detector, an accelerometer, a thermometer, a digital camera, a network card, a Universal Serial Bus (USB) port, a Global Positioning System (GPS) receiver, a Radio Frequency IDentification (RFID) receiver, a RF receiver, a pressure sensor, and a weight scale or mass balance.

Some embodiments described herein are associated with an “output device”. As used herein, the term “output device” may generally refer to a device that is used to output information. An output device may communicate with and/or be part of another device. Some examples of output devices may include, but are not limited to: a Cathode Ray Tube (CRT) monitor, a Liquid Crystal Display (LCD) screen, a Light Emitting Diode (LED) screen, a printer, an audio speaker (or other sound or noise-producing device), an Infra-red Radiation (IR) transmitter, a RF transmitter, a vibration device, an olfactory emitter, and/or a data port.

It should be understood that some devices may function and/or operate as both input and output devices. A touch-sensitive display device (or “touch screen”), for example, may both receive input by receiving pressure and/or electrostatic indications via a display screen and may also provide output such as graphics, text, and/or other data via the same display screen.

Some embodiments herein are associated with “communication”. As used herein, the term “communication” may refer to any information, data, and/or signal that is provided, transmitted, received, and/or otherwise processed by an entity, and/or that is shared or exchanged between two or more people, devices, and/or other entities. Communications may be external to one or more devices, internal (e.g., within a device and/or component), wired, wireless, continuous, and/or intermittent. Communications may involve, for example, one or more of transmitting, receiving, relaying, processing, and/or otherwise interfacing with information and/or data. Some, but not all, possible communication networks that may be utilized for such communications include: a Local Area Network (LAN), a Wide Area Network (WAN), the Internet, a telephone line (e.g., a Public Switched Telephone Network (PSTN)), a cable line, a radio channel, an optical communications line, and/or a satellite communications link. A variety of communications protocols may be utilized to facilitate and/or conduct such communications, including but not limited to: Ethernet (or IEEE 802.3), Internetwork Packet Exchange IPX), Service Advertising Protocol (SAP), Asynchronous Transfer Protocol (ATP), Bluetooth®, and/or Transmission Control Protocol (TCP)/Internet Protocol (IP). Communications may be encrypted to ensure privacy and prevent fraud in any of a variety of ways that are or become known or practicable.

Devices in communication with each other need not be continually transmitting to each other. On the contrary, such devices need only transmit to each other as necessary, and may actually refrain from exchanging data most of the time. For example, a device in communication with another device via the Internet may not transmit data to the other device for weeks at a time.

As used herein, the terms “information” and “data” may be used interchangeably and may refer to any data, text, voice, video, image, message, bit, packet, pulse, tone, waveform, and/or other type or configuration of signal and/or information. Information may be or include information packets transmitted, for example, in accordance with the IP Version 6 (IPv6) standard as defined by “Internet Protocol Version 6 (IPv6) Specification” RFC 1883, published by the Internet Engineering Task Force (IETF), Network Working Group, S. Deering et al. (December 1995). Information may, according to some embodiments, be compressed, encrypted, and/or otherwise packaged or manipulated in accordance with any method that is or becomes known or practicable.

In addition, some embodiments described herein are associated with an “indication”. As used herein, the term “indication” may be used to refer to any indicia and/or other information indicative of or associated with a subject, item, entity, and/or other object and/or idea. As used herein, the phrases “information indicative of” and “indicia” may be used to refer to any information that represents, describes, and/or is otherwise associated with a related entity, subject, or object. Indicia of information may include, for example, a code, a reference, a link, a signal, an identifier, and/or any combination thereof and/or any other informative representation associated with the information. In some embodiments, indicia of information (or indicative of the information) may be or include the information itself and/or any portion or component of the information. In some embodiments, an indication may include a request, a solicitation, a broadcast, and/or any other form of information gathering and/or dissemination.

As used herein, the term “coupled” may generally refer to any type or configuration of coupling that is or becomes known or practicable. Coupling may be descriptive, for example, of two or more objects, devices, and/or components that are communicatively coupled, mechanically coupled, electrically coupled, and/or magnetically coupled. The term “communicatively coupled” generally refers to any type or configuration of coupling that places two or more objects, devices, components, or portions, elements, or combinations thereof in communication. Mechanical, electrical, and magnetic communications are examples of such communications. The term “mechanically coupled” generally refers to any physical binding, adherence, attachment, and/or other form of physical contact between two or more objects, devices, components, or portions, elements, or combinations thereof. The term “electrically coupled” indicates that one or more objects, devices, components, or portions, elements, or combinations thereof, are in electrical contact such that an electrical signal, pulse, or current is capable of passing between the one or more objects, enabling the objects to electrically communicate with one another. The term “magnetically coupled” indicates that one or more objects, devices, components, or portions, elements, or combinations thereof, are within one or more associated magnetic fields. Objects may be electrically and/or magnetically coupled without themselves being physically attached or mechanically coupled. For example, objects may communicate electrically through various wireless forms of communication or may be within (at least partially) a magnetic field, without being physically touching or even adjacent.

### General System

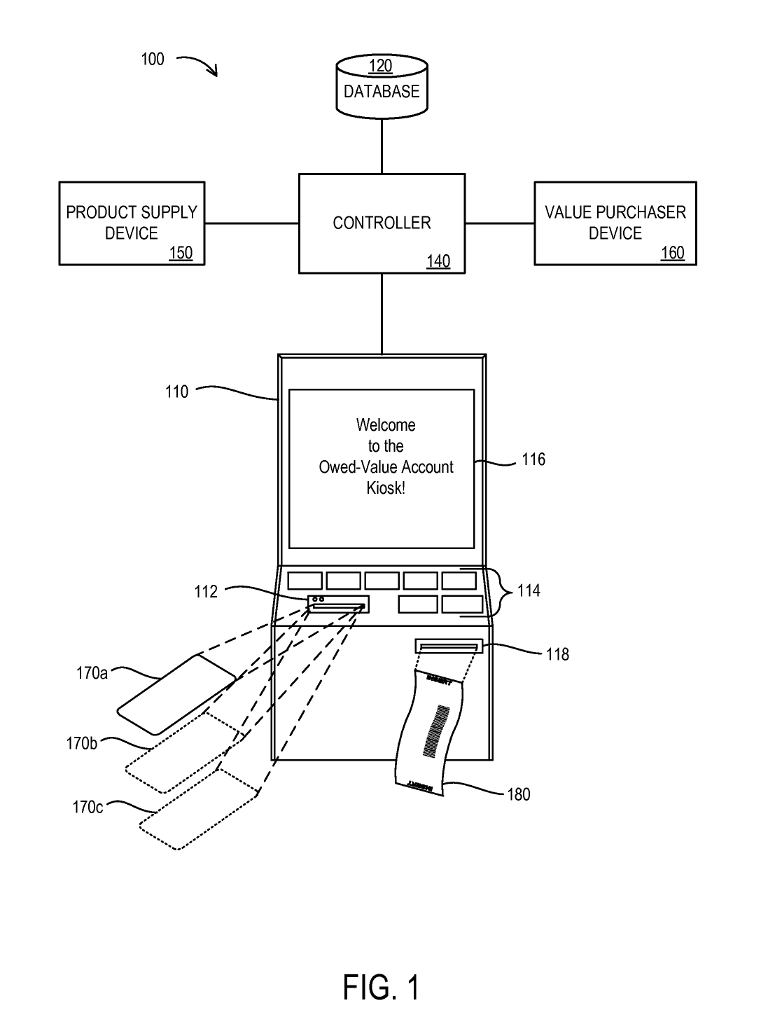

Referring first to FIG. 1, a block diagram of a system 100 according to some embodiments is shown. The various systems described herein are depicted for use in explanation, but not limitation, of described embodiments. Different types, layouts, quantities, and configurations of systems described herein may be utilized without deviating from the scope of some embodiments. And while specific machines and types/configurations of specific machines are depicted for use in explanation of how embodiments may be implemented, it should be understood that other substantially functionally equivalent specific machines may alternatively be utilized as is or becomes desirable and/or practicable.

In some embodiments, the system 100 may comprise (as shown in FIG. 1, for example) a terminal 110. The terminal 110 may be or may include any type and/or configuration of device that is or becomes known or practicable. In some embodiments, the terminal 110 may comprise a kiosk (e.g., as depicted in FIG. 1), a vending machine, a POS device, a retail terminal (e.g., a lottery terminal such as an ALTURA® lottery terminal manufactured by GTECH Corporation of West Greenwich, R.I.), an ATM machine, a cellular telephone, a portable computing device, a web-access device and/or browser or server, and/or any combination thereof. The terminal 110 may generally, for example, be utilized by a customer to participate in the embodiments described herein.

According to some embodiments, the terminal 110 may comprise an OVC interface 112 (e.g., an input device), buttons 114 (e.g., an input device), a display device 116 (e.g., an output device; and/or an input device in the case of a touch screen), and/or a dispensing device 118 (e.g., an output device).

In some embodiments, the terminal 110 may be coupled to and/or in communication with a database 120, a controller 140, a product supply device 150, and/or a value purchaser device 160. The terminal 110 may be utilized by a customer, for example, to provide indications to the database 120 and/or controller 140 (either of which may be local or remote from the terminal 110), such indications generally being directed to providing and/or requesting information associated with an OVA held/owned by the customer. According to some embodiments, the terminal 110 may receive customer selections and/or definitions of OVA parameters (e.g., upon setting up and/or editing an OVA and/or preferences thereof), receive customer selections and/or definitions of breakage conditions and/or rules (such as whether the customer desires to have any breakage amount remaining in the OVA automatically utilized to purchase specific products, lottery entries, and/or fractional lottery entries on behalf of the customer), receive an OVC 170a-c from the customer (e.g., to read OVA information from the OVC 170a-c and/or to take possession of the OVC 170a-c, such as in the case that the customer deposits and/or surrenders an OVC in exchange for a products, service, and/or lottery entry), dispense an OVC 170a-c to a customer, dispense a product 180 to the customer (e.g., such as an indicia of a lottery entry and/or an electronic or consumable product—e.g., a cell phone, an NC adapter, a ring tone, an MP3 file, an audio and/or e-book, a drink, and/or a snack), retrieve OVA information from the database 120 and/or the controller 140, and/or transmit information to the database 120 and/or controller 140.

In some embodiments, the customer may utilize the terminal 110 to establish and/or replenish an OVA. The customer may, for example, make selections via the buttons 114 and/or display device 116 (e.g., softkeys on a touch screen) to open an OVA. The customer may also make selections defining conditions defining when and how a balance of the OVA may be converted into one or more predefined products and/or services. The terminal 110 may also or alternatively be utilized by the customer to replenish a balance of an existing OVA, surrender an OVC in exchange for one or more products and/or services, and/or deposit a plurality of OVCs with a request that the balances of the plurality of OVCs be consolidated in a single OVA and/or on a single OVC (e.g., either one of the deposited OVCs or a new OVC).

The database 120 may generally comprise any type and/or configuration of data storage device that is or becomes know or practicable. The database 120 may, for example, comprise a memory device coupled to and/or local to the terminal 110, and/or may comprise one or more memory devices residing remotely from the terminal 110 (e.g., on a central server; not explicitly shown). The database 120 may store various information and/or data that may be desirable and/or useful for carrying out any or all of the various embodiments described herein. The database 120 may store, for example, instructions that are operable to cause processing devices (e.g., the controller 140) to execute and/or facilitate execution of embodiments described herein, information descriptive of one or more OVAs and/or OVCs, information associated with a customer (e.g., a customer utilizing the terminal 110), information descriptive of products and/or services that are available (e.g., via one or merchants associated with the product supply device 150) and/or that have been designated to be automatically purchased on behalf of the customer utilizing a remaining balance of an OVA/OVC, and/or information descriptive of one or more purchasers (e.g., associated with the value purchaser device 160) of OVA/OVC balances (e.g., one or more auction winners, in some embodiments).

The controller 140 may generally comprise any type or configuration of processing and/or logic device that is or becomes known or practicable. The controller 140 may comprise one or more CPU devices and/or chipsets, for example, and/or may comprise a switchboard, Printed Circuit Board (PCB), logic unit, firmware, software, and/or any combinations thereof. The controller 140 may comprise, for example, a CPU of the terminal 110 or may comprise one or more central and/or remote servers in communication with the terminal 110.

In some embodiments, the controller 140 may be specifically programmed and/or specifically coupled (e.g., to the database 120) to execute embodiments described herein. The controller 140, for example, may receive and/or process customer indications received via the terminal 110. Based on such indications, the controller 140 may, for example, cause data to be retrieved from and/or stored in the database 120, cause a balance of an OVA/OVC to be replenished, reduced, established, sold (e.g., to a purchaser associated with the value purchase device 160), transferred, and/or utilized to purchase one or more products and/or services (e.g., from a merchant and/or other entity associated with the product supply device 150).

The product supply device 150 and the value purchaser device 160 may comprise any types of network and/or user device that are or become known or practicable. The product supply device 150 may generally be associated with, owned, and/or operated by an entity that provides products and/or services which are available for purchase and/or that are purchased utilizing a balance of an OVA/OVC (e.g., a breakage balance). The product supply device 150 may comprise, for example, a computing device, product storage device, and/or product delivery device associated with a lottery (e.g., the New York State Lottery®), an online merchant (e.g., Amazon®), and/or a brick-and-mortar merchant (e.g., Wal-Mart®).

The value purchaser device 160 may generally be associated with, owned, and/or operated by an entity that purchases a balance of an OVA/OVC (e.g., a breakage balance). The purchasing entity may, in some embodiments, comprise a retailer such as Home Depot® (e.g., that purchases a balance of a competitor's OVC in exchange for providing a benefit such as a product, credit, and/or a Home Depot® OVC to the customer) or an auction-winning entity (e.g., an entity that has won an auction for an OVA/OVC balance—such as a balance that is not expressed, or not easily or readily expressed, in terms of cash equivalency).

According to some embodiments, one or several of the components of the system 100 may not be needed and/or desired to carry out some embodiments described herein. In embodiments where the controller 140 analyzes and/or searches mass OVA data to locate breakage conditions, for example, the terminal 110 may not be included in the system 100 (e.g., since customer interaction may not be required). In some embodiments, the product supply device 150 and/or the value purchaser device 160 may comprise a single device and/or may be associated with, owned, and/or operated by the same entity. Similarly, in the case that an entity that is associated with, owns, and/or operates the controller 140 is the same entity as is associated with either or both of the product supply device 150 and/or the value purchaser device 160, any or all of the devices 140, 150, 160 may comprise a single device (e.g., a lottery entity may own and/or operate a terminal 110 such as a stand-alone kiosk that may perform substantially all functionality of each of the terminal 110, the controller 140, the product supply device 150 and/or the value purchaser device 160).

### Lottery Embodiments

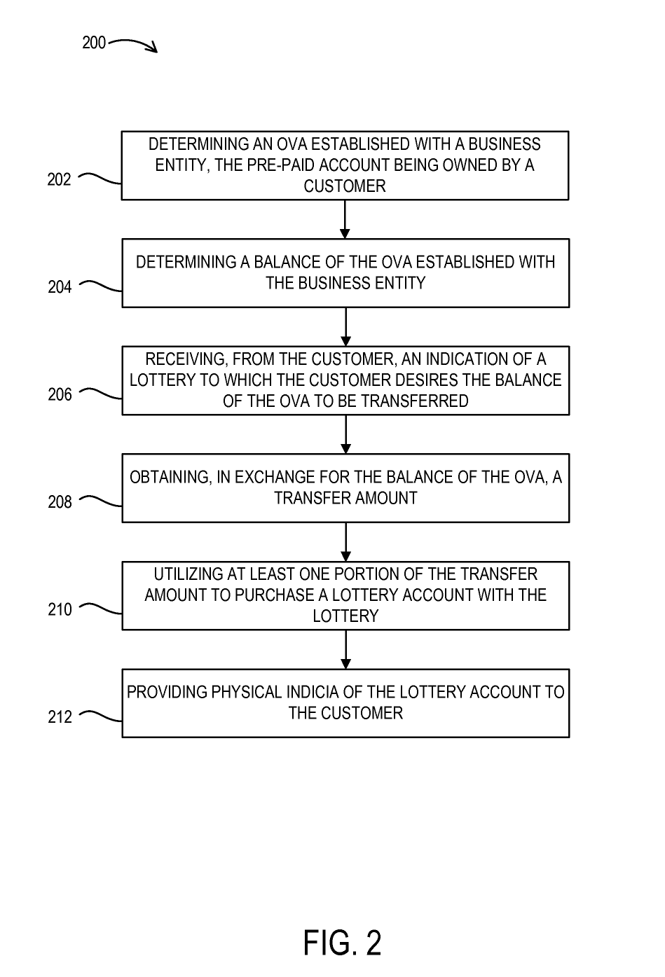

Referring now to FIG. 2, a flow diagram of a method 200 according to some embodiments is shown. In some embodiments, the method 200 may be performed and/or implemented by and/or otherwise associated with the system 100 described in conjunction with FIG. 1. The methods, procedures, and/or processes described herein may generally be performed by the system 100 of FIG. 1 and/or any of the many components and/or devices (and/or combinations thereof) described herein. Other configurations of systems and devices may also or alternatively be utilized to perform the methods described herein without deviating from the scope of some embodiments. The procedures described herein do not necessarily imply a fixed order to the actions, and embodiments may be performed in any order that is practicable. Note that any of the methods described herein may be performed by hardware, software (including microcode), firmware, or any combination thereof. For example, a storage medium may store thereon instructions that when executed by a machine result in performance according to any one or more of the embodiments described herein.

According to some embodiments, the method 200 may comprise determining a OVA established with a business entity, the OVA being owned by a customer, at 202. A processor and/or controller or other device (e.g., the controller 140 and/or the terminal 110 of FIG. 1) may, for example, analyze and/or search data records (e.g., stored in a database such as the database 120 of FIG. 1) of OVAs to determine information associated with and/or descriptive of such OVAs. In some embodiments, such a process may be scheduled and/or may be triggered by one or more events, such as the occurrence and/or identification of a truncation involving an OVA. According to some embodiments, the determining may comprise receiving, from the customer, an indication of an OVA (e.g., such as an account number, a PIN, and/or an OVC). The customer may, for example, insert (and/or swipe) an OVC associated with an OVA into a kiosk and/or other terminal such as the terminal 110 of FIG. 1. In response to such an event, information associated with the OVA/OVC may then be searched for, looked up, retrieved, and/or otherwise determined.

The method 200 may also or alternatively comprise determining a balance of the OVA established with the business entity, at 204. A processor, controller, and/or terminal (e.g., the controller 140 and/or the terminal 110 of FIG. 1) may, for example, read an OVC provided by the customer and/or may retrieve information from a database (e.g., the database 120 of FIG. 1) to determine a balance of the OVA.

The method 200 may also or alternatively comprise receiving, from the customer, an indication of a lottery to which the customer desires the balance of the OVA to be transferred, at 206. In some embodiments, the customer may provide such an indication upon opening of the OVA or after opening the OVA (e.g., editing preferences of the OVA). According to some embodiments, the customer may provide such an indication after initiating a session at a terminal or other user device operable to function in accordance with embodiments described herein (e.g., the terminal 110 of FIG. 1). Upon inserting and/or swiping an OVC via a user device, for example, the user device may provide the customer a menu of available options regarding the OVA/OVC. The balance of the OVA/OVC (e.g., determined at 204) may be provided to the customer and/or a menu of options descriptive of how the customer may desire to utilize the balance may be presented.

While many options of how to utilize the balance are described herein, this section concentrates on embodiments where the customer desires to transfer the balance of the OVA to a lottery and/or lottery account. The customer may own a lottery account, for example, and/or may wish to establish a new lottery account utilizing the OVA balance. In such embodiments, the customer may be presented with a menu from which the customer may select one or more of a plurality of available lotteries to which the balance is desired to be applied. The customer may, for example, pick the New York State Lottery® from a list of available lotteries.

The method 200 may also or alternatively comprise obtaining, in exchange for the balance of the pre-paid account, a transfer amount, at 208. An entity that obtains the information regarding the OVA may, for example, offer the customer an amount of money and/or other consideration in exchange for the OVA/OVC and/or the balance thereof. In some embodiments, a user device/terminal and/or a processor/controller may offer the OVA/OVC and/or balance thereof to one or more third-parties in exchange for the transfer amount (which amount may be set and/or defined by the offering entity or may be variable or set by the purchaser). According to some embodiments, the OVA/OVC and/or balance thereof may be offered at auction. This may be particularly advantageous in cases where the balance of the OVA/OVC is not immediately, readily, and/or easily expressed in terms of currency equivalents (e.g., non-cash value award points, qualitative benefits such as preferred treatment options, and/or) or where the cash equivalent is substantially small (e.g., twelve cents ($0.12) for ten thousand (10,000) airline miles) but may be substantially desirable and/or more valuable to certain individuals (e.g., an individual may only need ten thousand (10,000) more airline points to obtain a free airline ticket, and thus may be willing to pay, for example, up to ten dollars ($10) for the needed miles).

The method 200 may also or alternatively comprise utilizing at least one portion of the transfer amount to purchase a lottery account with the lottery, at 210. The transfer amount obtained in exchange for the OVA/OVC and/or balance thereof may, in some embodiments, be utilized in entirety to purchase a lottery account, entry, and/or ticket for the customer (e.g., on behalf of the customer). In some embodiments, the entity that facilitates, manages, and/or executes the method 200 and/or portions thereof may retain a portion of the transfer amount as a fee. A five dollar ($5) balance of an OVA may fetch ten dollars ($10) from a business in competition with the business entity associated with the OVA, for example, three dollars ($3) may be retained by an entity owning a kiosk implementing the method 200, and the remaining seven dollars ($7) may be utilized to open a lottery account for the customer. In such an embodiment, the customer may informed of the involvement of the competing business entity in the transaction (e.g., directly and/or by being served advertisements from the competing business entity). In such a manner, for example, the competing business entity is likely to make a new customer by increasing the value of the OV to the customer, the entity executing the method 200 receives fee revenue, and the lottery (e.g., selected and/or otherwise defined by the customer at 206) receives revenue as well.

The method 200 may also or alternatively comprise providing physical indicia of the lottery account to the customer, at 212. A lottery account statement, lottery ticket, fractional lottery ticket, and/or lottery voucher may, for example, be mailed and/or e-mailed to the customer and/or may be printed (e.g., via the terminal 110 of FIG. 1) and/or dispensed to the customer. In such a manner, for example, the customer may utilize a kiosk (or other terminal or user device) to convert balances of OVAs into lottery entries.

The method 200 may be advantageously employed in cases where the balance of the OVA is determined to be breakage. OVA records may be searched, for example, to identify OVAs that meet breakage criteria (e.g., established by law, set by a controlling entity, and/or set or defined by the customer). Balances of such identified OVAs may then, for example, be converted into lottery entries, transferred into lottery accounts, and/or otherwise processed as described herein and in accordance with one or more stored rules (e.g., default or standard rules and/or rules selected and/or defined by customers). In such a manner, for example, otherwise lost or wasted “breakage” balances may be converted (e.g., automatically) into products and/or services, such as lottery tickets and/or fractional lottery tickets, that are beneficial to the customer (and the lottery).

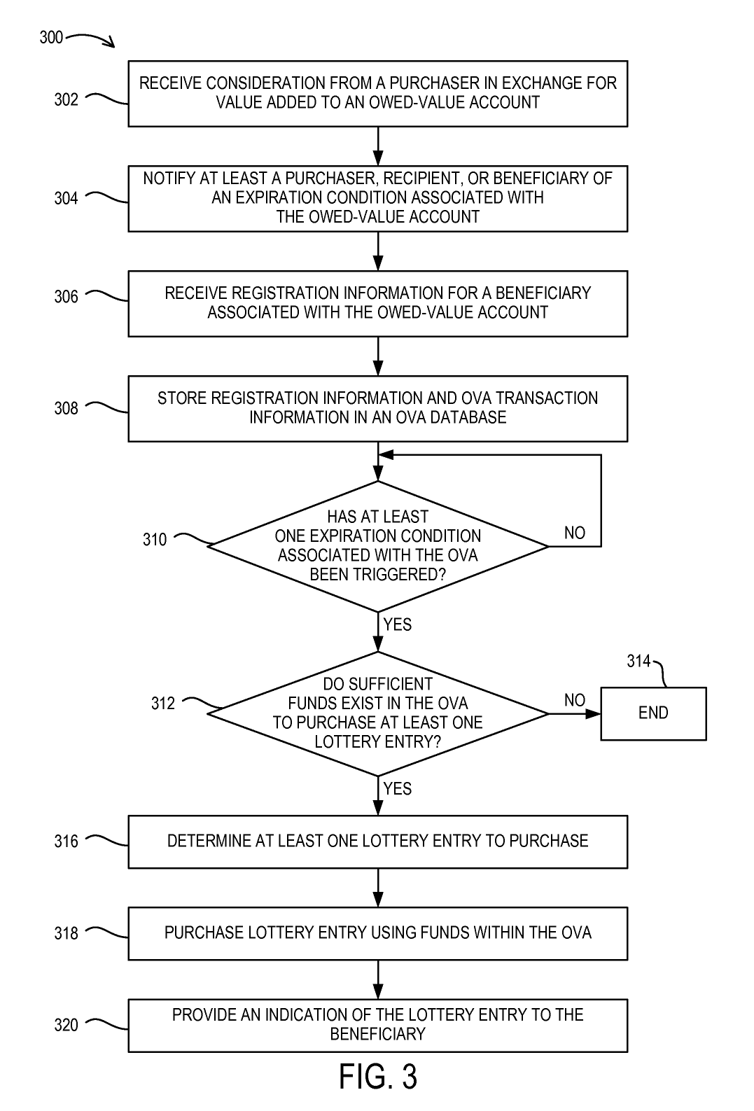

Referring now to FIG. 3, a flow diagram of a method 300 according to some embodiments is shown. In some embodiments, the method 300 may be performed and/or implemented by and/or otherwise associated with the system 100 described in conjunction with FIG. 1. In some embodiments, the method 300 may be associated with and/or comprise the method 200 of FIG. 2 and/or any portion thereof.

According to some embodiments, the method 300 may comprise receiving consideration from a purchaser in exchange for an OV of an OVA, at 302. In some embodiments, this procedure may be similar to, coincident with, and/or comprise or otherwise be related to the procedure at 208 of the method 200 of FIG. 2. A purchaser of a balance of an OVA account may be sought, for example, such as by offering, marketing, and/or auctioning the balance. According to some embodiments, the purchaser may agree to provide and/or provide a transfer amount in consideration for the balance of the OVA and/or in consideration for an OVC associated with the OVA (e.g., in exchange for a surrendering and/or destruction of the OVC).

The method 300 may also or alternatively comprise notifying at least a purchaser, recipient, or beneficiary of an expiration condition associated with the OVA, at 304. The expiration condition may comprise, for example, a minimum balance of the OVA being reached, the minimum balance persisting for a predetermined threshold amount of time, an amount of time since a last transaction involving the OVA having been consummated, etc. Some or all of these conditions may comprise “breakage” conditions as defined by law or otherwise.

In general, one or more expiration conditions may be associated with an OVA in order to determine when and if an OV may be used to pay for an entry into a game of chance. An expiration condition associated with an OVA may be specified by one or more of the following: a purchaser, a recipient, a beneficiary, a merchant, a lottery administrator, a third party. In some embodiments, a merchant may choose a set of, for example, ten (10) expiration conditions to offer a beneficiary. The beneficiary may then be required to choose one of the ten (10) he wishes to associate with an OVA.

In some embodiments, a recipient of a gift card associates three (3) different expiration conditions with the balance of the gift card. The recipient designates that if any one of the three (3) expiration conditions is triggered, that the remaining balance of an associated OVA be converted into lottery entries. In some embodiments, the state of California may determine that a balance within an OVA must be below a value of five dollars ($5) in order for the balance to be converted into one or more lottery entries.

In some embodiments, more than one expiration condition may need to be triggered before an OVA balance can be used to purchase a lottery entry. For example, a beneficiary designates the following three (3) expiration conditions for the balance of a one hundred dollar ($100) gift card: a date six (6) months from a first use of the gift card is reached, the balance of the gift card drops below ten dollars ($10), and more than three (3) separate purchases are made with the gift card. The beneficiary also designates that if any two (2) of the three (3) conditions are determined to be true, the balance remaining on the gift card shall be used to purchase a maximum number of entries into a game of chance.

One or more parameters may be used when establishing an expiration condition associated with an OVA. Examples of expiration conditions based on quantifiable parameters include, but are not limited to: (i) a specified date has passed (e.g., a gift card states that its expiration date is on Jan. 1, 2010); (ii) a specified time period has lapsed (e.g., in one embodiment, the time period may begin at a time of purchase associated with an OVA; in another embodiment, a time period may be associated with a first use of an OVA balance; in yet another embodiment, the time period may be associated with a most recent use of an OVA balance—e.g., a calling card states any owed-value remaining on the card after one (1) year from first use will be unavailable for use in placing telephone calls, and automatically be sent to a beneficiary in the form of lottery entries); (iii) a period of inactivity associated with an OVA has passed (e.g., frequent flier miles are set to expire after three (3) years of account inactivity (i.e., no miles redeemed or credited); upon reaching an expiration condition, an owner of the frequent flier miles may receive an equivalent value of lottery tickets in lieu of the miles); (iv) an OV associated with an OVA has fallen below a minimum threshold (e.g., an amount spent from an OVA exceeds a maximum threshold—e.g., the balance on a calling card falls below a threshold value of two dollars ($2.00), causing the remaining balance to expire (with respect to use of the calling card); the balance is then automatically used to purchase a lottery entry and a lottery voucher for an owner of the calling card); (v) a maximum number of transactions associated with an OVA have been exceeded (e.g., a remaining balance on a calling card may automatically be used to purchase one or more lottery entries after the calling card has been used forty (40) times); (vi) a lottery jackpot reaches a threshold amount (e.g., an expiration condition may occur if the New York State Lottery reaches a jackpot amount of at least one hundred and fifty million dollars ($150 million); this provides a guarantee to the purchaser, recipient, or beneficiary that the lottery entries purchased will be for a drawing of sufficient size, and may also provide a guarantee that a large drawing will not be missed because of inattentiveness).

An expiration condition may be reached voluntarily or involuntarily. Examples include: (i) an OVA is terminated voluntarily—e.g., a merchant receives a request from a gift card recipient to receive the remaining balance on the gift card in cash; since the balance remaining on the gift card is above a minimum threshold value, it is against the merchant's policy to pay out the balance in cash; instead, the merchant offers the recipient a number of lottery entries equivalent to the balance remaining on the gift card); (ii) an OVA is terminated involuntarily—e.g., a merchant determines an owner of a gift card is determined to be deceased and terminates an OVA associated with the gift card.

Detecting that an expiration condition has occurred may be determined by, for example: (i) a controller operatively connected to a customer database or an OVA database (e.g., a controller may periodically poll an OVA database (e.g., on a daily basis) to determine which expiration conditions have occurred; e.g., a calling card user first dials an access number in order to be connected with an intended calling party; a controller operatively connected with a phone switch determines that the calling card being used has at least one expiration condition that has been triggered—e.g., the controller directs an IVRU to notify the calling card user of the expiration condition); (ii) a POS terminal or a controller operatively connected to a POS terminal (e.g., a POS terminal determines that a gift card that has just been used by a recipient to purchase an item, has a remaining balance that is less than a threshold amount; the POS terminal causes a cashier to prompt the recipient, “Would you like to receive the remaining balance of your gift card as lottery tickets?”); (iii) a cashier or representative associated with an OVA may determine that an expiration condition has been triggered (e.g., a cashier operating a POS terminal notices that a remaining balance on a gift card has dropped below a threshold level of five dollars ($5.00); the cashier has been trained to recognize this threshold level and informs the owner of the gift card of one or more lottery entries that he is eligible to receive.

The method 300 may also or alternatively comprise receiving registration information for a beneficiary associated with the OVA, at 306. Upon a customer signing up for and/or otherwise acquiring the OVA, for example, the customer may designate a beneficiary whom may benefit in the case that the expiration condition becomes triggered and/or satisfied (e.g., the OVA becomes classified as breakage). In some embodiments, a registration process may be used to determine information about the beneficiary, so that a lottery entry or outcome may later be provided to the beneficiary. Information associated with the beneficiary may be received by, for example: a merchant, a lottery authority, a lottery retailer, or a third party. In some embodiments, the information may be used to aid an exchange of OV for a lottery entry and to notify a beneficiary of a lottery entry. For example, a party (e.g., a purchaser, recipient, beneficiary) may be required to disclose information such as: a mailing address, a legal name, and/or a birth date in order to insure that a beneficiary is entitled to the lottery entry and that the party is able to receive an indication of the lottery entry.

Registration information may be collected, in some embodiments, for the following parties, any of which may be beneficiaries: (i) a purchaser associated with an OVA; (ii) a recipient associated with an OVA; and/or (iii) a third-party beneficiary of an OVA, who may be designated by a purchaser or recipient. For example, a recipient of a gift card that is under the age of 18 may be ineligible to receive a lottery entry. Using a registration website, the recipient may enter the name and address of the recipient's guardian and/or parent, and designate the guardian and/or parent to receive any lottery entries (or other products or services) associated with expiration of the gift card.

In some embodiments, any or all the following information may be collected during the registration process: (i) a mailing address (e.g., a mailing address where an indication of a lottery entry should be mailed); (ii) an e-mail address (e.g., an e-mail address of a calling card purchaser, such that the purchaser may be notified when an expiration condition associated with the calling card has been triggered); (iii) a username and/or password that a party may use to access and/or update information associated with an OVA; (iv) one or more telephone numbers (e.g., a home phone, mobile phone, work phone); (v) information associated with a government issued ID, such as a driver's license number, a passport number, a social security number; (vi) information associated with a rewards program, such as: a frequent flier number and/or a casino player's card number; (vii) a legal name of a lottery entry beneficiary (e.g., a recipient may provide his own name if he would like to receive one or more lottery entries obtained via OV breakage; in some embodiments, more than one beneficiary name may be provided in case a primary beneficiary is unable to be located, e.g., a purchaser may provide their own name; in some embodiments, lottery entries obtained via owed-value breakage may be shared between more than one beneficiary.); (viii) a beneficiary's bank account number and bank routing number (e.g., winning payouts may automatically be credited to a beneficiary's bank account); (ix) a beneficiary's income tax information (e.g., Winning payouts may be paid via a beneficiary's tax return; also, a beneficiary's winning payout amount may require automatic reporting to the IRS as income); (x) one or more preferences associated with a game of chance (e.g., a beneficiary may provide a preferred lottery entry and denomination that they would like to receive; the beneficiary may also provide information for a second and third type of preferred lottery entry they would like to receive in exchange for an owed-value balance); (xi) one or more expiration conditions may be specified by the registrant (e.g., chosen from a list of allowable expiration conditions).

Information or preferences collected from a first party may be that of the first party or of a second party. For example, a purchaser of a gift card may provide the name and address of an intended gift card recipient. In some embodiments, a gift card recipient may provide the name and email address of a third-party beneficiary.

Registration information may be collected at various times throughout the processes detailed herein. The following are non-limiting examples of when registration information may be collected: (i) at time of purchase (e.g., registration information may be required to be entered into a merchant's POS terminal in order for a gift/calling card to be purchased); (ii) at a time when a portion of owed-value is redeemed (e.g., a gift card recipient may be required to disclose registration information when using a portion of the gift card's balance for the first time); (iii) at a time when an expiration condition associated with an OVA has been triggered; (iv) at any time prior to a beneficiary receiving a lottery entry (e.g., one month after a recipient receives a gift card, but before an expiration condition has been triggered, the recipient calls an “800” telephone number and communicates any required registration information to an operator); (v) at a time when an OVA is established (for example, registration information may be collected by a casino when a player signs up for a player's comp card).

Registration information may generally be collected via one or more of the following means: (i) a website that prompts a party to enter registration information; (ii) a telephone operator or Interactive Voice Response Unit (IVRU) collects a party's registration information via telephone; (iii) a cashier at a merchant collects a party's registration information at a POS terminal; (iv) a party is required to fill out a registration form on paper (e.g., the registration form may be manually entered or automatically scanned into an OVA or customer database); (v) a party may operate a kiosk to input registration information (e.g., a purchaser may swipe his credit card at a kiosk, and the kiosk may determine the purchaser's mailing address according to information stored by his credit card provider); (vi) prior to receiving a lottery entry a lottery terminal or kiosk may prompt a party to enter their registration information.

In some embodiments, registration information is received at a POS terminal. The POS terminal may then transmit the registration information to a central server, for example, which in turn stores the information in an OVA database.

In yet another embodiment, a merchant may have already received a purchaser's contact information during a previous transaction (e.g., a merchant may have recorded and stored within a customer database, a purchaser's name, address, and phone number when purchasing an item and extended warranty). In this embodiment, a central server administering an OVA database may access the purchaser's information within a customer database as needed. The purchaser may be required to confirm that the previously received contact information is accurate.

The method 300 may also or alternatively comprise storing the registration information and OVA transaction information in a database, at 308. The information may be stored, for example, in a database such as the database 120 of FIG. 1.

The method 300 may also or alternatively comprise determining whether the expiration condition associated with the OVA has been triggered, at 310. One or more stored rules may be evaluated, for example, to determine if an event has occurred that satisfies and/or triggers an expiration condition, such as breakage, of the OVA. In the case that it is determined that the expiration condition has not been triggered, the method 300 may continue monitoring for an event that triggers the expiration condition, such as by looping at 310. In the case that it is determined that the expiration condition has been triggered, the method 300 may continue, in some embodiments, by proceeding to 312.

The method 300 may also or alternatively comprise determining whether sufficient funds exist in the OVA to purchase at least one lottery entry, at 312. In the case that a minimum amount of money is required to purchase a lottery ticket (e.g., one dollar ($1)), for example, the OVA balance may need to be equal to or greater than such an amount to warrant a purchase of the lottery ticket on behalf of the beneficiary. In some embodiments, such as in the case that fractional lottery tickets are permitted and/or lottery vouchers may be issued, the balance of the OVA may not be of great importance and accordingly may not need to be checked or verified. In the case that it is determined that sufficient funds do not exist, the method 300 may end by proceeding to 314. In the case that it is determined that sufficient funds do exist, the method 300 may continue, in some embodiments, by proceeding to 316.

The method 300 may also or alternatively comprise determining at least one lottery entry to purchase, at 316. The balance of the OVA may be compared to available lottery purchase options, for example, to determine a type and/or quantity of lottery products that may be purchased for the beneficiary. When an expiration condition occurs, at least one lottery entry may be purchased using at least a portion of the balance associated with OVA. Note that the term lottery entry may refer to: (i) an entry into a single state (e.g., New York, California) or multi-state (e.g., Mega Millions) lottery; (ii) an entry into a sweepstakes (there may be at least two ways of entering a sweepstakes—a free manner (e.g., by sending in a postcard), and a paid manner (e.g., the expiration or donation of a balance of an OVA)); (iii) a keno entry; (iv) a sports bet or other bet on an event (for example, an OVC may be associated with a particular sports team (e.g., the Pittsburgh Steelers); when an expiration condition associated with the OVA occurs, then a portion of the remaining balance of the OVA may be used to place a bet on the sports team (e.g., that the Pittsburgh Steelers will win their next game, or that the Pittsburgh Steelers will win the Super Bowl that year); (v) an entry into a game of chance.

A lottery authority, merchant, or third-party may provide a beneficiary with a plurality of lottery entries to choose from in exchange for a specified amount of breakage. Alternately or in addition, in some embodiments, one or more lottery entries may be automatically chosen for a beneficiary. In one embodiment, a controller operatively connected to an OVA database may aid in determining one or more lottery entries to provide to a beneficiary. In another embodiment, a cashier or lottery representative may determine a lottery entry to provide to a beneficiary. One or more of the following factors may be used in determining a lottery entry to provide: (i) an owed-value balance (for example, a larger breakage amount may be eligible to be redeemed for a “more desirable” type of lottery entry; e.g., five dollars ($5.00) in breakage may only be redeemed for a single five dollar ($5.00) “Wild Jacks” lottery entry, while twenty dollars ($20) in breakage may be redeemed for any combination of the “Wild Jacks” entry and a higher-payout five dollar ($5.00) “Big Money” lottery entry; (ii) one or more processing fees—a processing fee may be deducted from a beneficiary's eligible breakage when determining a number of lottery entries to be provided to the beneficiary; (iii) a wholesale cost of one or more lottery entries—a price that a lottery retailer, merchant, or third-party may purchase one or more lottery tickets at; e.g., a merchant may purchase a roll of one hundred (100) one dollar ($1.00) face-value lottery entries for a wholesale price of eighty-five dollars ($85.00) (instead of one hundred dollars ($100.00)); the merchant may elect to provide the one hundred dollars ($100) in face-value lottery entries to a beneficiary who only has eighty-five dollars ($85) in eligible breakage to redeem); (iv) information or preferences that may have been received from a purchaser, recipient, or beneficiary (examples include: a preferred denomination of lottery entry, a preferred type of lottery entry (e.g., scratch, pick 6), preferred lottery game (e.g., “Deuces Wild” scratch card vs. “Texas Tea” scratch card), a preferred drawing date, one or more preferred lottery entry parameters (e.g., favorite lotto number); for example, a purchaser may indicate his preference for a particular game, denomination, or drawing date by purchasing an owed-value card that is specific to that game, denomination, or drawing date (e.g., a card that, when an expiration condition occurs, is used to purchase “Lucky 7” scratch tickets)); (v) geography associated with a purchaser, recipient, or beneficiary (e.g., a controller determines that a beneficiary is eligible to receive thirty-five dollars ($35) in lottery entries; the beneficiary has just triggered an expiration condition associated with the thirty-five dollars ($35) in the state of California; since the beneficiary's home address is in the state of Connecticut, the beneficiary is offered thirty-five dollars ($35) in “live” tickets from California, thirty-five dollars ($35) in lottery vouchers eligible to be redeemed in Connecticut, or any combination of the two; in a second example, the location of a beneficiary's mobile phone (e.g., which state) may be used to determine which lottery entries are provided to the beneficiary); (vi) maximizing use of breakage—a controller may be programmed to efficiently use breakage by maximizing a number of lottery entries to provide and minimizing a number of lottery vouchers (e.g., a controller determines that a beneficiary associated with twenty-three dollars and seventy-five cents ($23.75) in breakage should be issued: two (2) ten dollar ($10.00) lottery entries, one (1) two dollar ($2.00) lottery entry, one (1) one dollar ($1.00) lottery entry, and a seventy-five cent ($0.75) lottery voucher.

A beneficiary may be prompted to confirm that they would like to receive one or more types of lottery entries/vouchers. For example, a beneficiary may receive an email stating, “$20 in expired Goody Dollars will be used to purchase a $20 ‘Super 7’ lottery ticket in your name. Click OK, or Click HERE for more lottery ticket options.”

The method 300 may also or alternatively comprise purchasing the at least one lottery entry utilizing the balance of the OVA, at 318. The lottery product determined at 316, for example, may be purchased on behalf of the beneficiary. In some embodiments, only a portion of the balance of the OVA may be utilized—the remainder being retained as fee payment, for example. In some embodiments, a controller associated with an OVA database (e.g., a merchant controller or calling card controller) may communicate instructions for purchasing a lottery entry/voucher to a lottery controller. In one embodiment, a merchant's controller may direct a transfer of a breakage balance into an account associated with a lottery authority. The merchant's controller may also indicate one or more lottery entries/vouchers to be purchased. Upon receiving confirmation of the transfer and an indication of entries/vouchers to purchase, the lottery controller may issue the specified lottery entries/vouchers to a beneficiary.

In one embodiment, a merchant or calling card controller may indicate to a lottery controller: (i) a lottery entry or coupon to purchase (e.g., as described as being determined herein); (ii) one or more beneficiaries associated with the lottery entry or coupon; (iii) a source of funds to be used to purchase the lottery entry or coupon (e.g., a merchant controller may automatically initiate a wire transaction from a merchant's financial account to a lottery's financial account; this transaction may be used to purchase the lottery entry or coupon); (iv) additional beneficiary information that may have been received during a registration process (e.g., a preferred delivery method for a lottery entry, a preferred lottery number to associate with a lottery entry).

An indication of a purchased lottery ticket or coupon may be stored in an OVA database, customer database, or associated lottery database. In one embodiment, a quantity and denomination of purchased lottery entries may be stored in an OVA database. If a lottery entry is purchased using a breakage balance, an OVA database may also be updated to reflect a new breakage amount (e.g., a balance of zero reflects an entire breakage balance being used to purchase one or more lottery entries).

In one or more embodiments, where a service fee may be applicable, the service fee may be transferred from a breakage balance to a financial account associated with a merchant, calling card company, lottery authority, lottery retailer or third party. In yet another embodiment, a beneficiary may be need to redeem a lottery coupon at a lottery retailer in order to receive a lottery entry. In an example of this embodiment, the following may occur: (i) a lottery controller may determine that a beneficiary is entitled to receive nine dollars and forty-none cents ($9.49) worth of lottery entries and coupon(s) due to a breakage balance associated with a merchant OVA; (ii) the controller determines that the beneficiary should receive three dollars ($3.00) in lottery entries and a forty-nine cent ($0.49) lottery coupon to most efficiently use this breakage balance; (iii) the lottery controller may send the beneficiary (e.g., via standard mail, email) three (3) coupons, each redeemable for a single three dollar ($3.00) lottery entry and a forty-nine cent ($0.49) lottery coupon redeemable for a discount on any additional lottery entry; (iv) the lottery controller may update an OVA database directly, or indirectly via a merchant controller—the update to the OVA database may indicate that the lottery coupons have been sent to the beneficiary; (v) the beneficiary receives the lottery coupon(s); (vi) a lottery retailer receives a request for redemption of the lottery coupons from the beneficiary (e.g., the lottery coupons may have one or more markings indicating that they may be redeemed by a specific beneficiary, and require ID prior to redemption; thus, the beneficiary may be required to provide the lottery coupons, along with a form of acceptable ID to the lottery retailer before he can receive his lottery entries); (vii) the beneficiary provides his ID and receives the three (3) three dollar ($3.00) lottery entries and/or the beneficiary provides the forty-nine cent ($0.49) lottery coupon and two dollars and fifty-one cents ($2.51) in cash in order to receive a fourth three dollar ($3.00) lottery entry; and/or (viii) upon redemption, a lottery kiosk located at the lottery retailer directs the lottery controller to update the OVA database to reflect the new status of the lottery coupons (the status of the coupons may be changed, for example, from “issued” to “redeemed”).

The method 300 may also or alternatively comprise providing an indication of the at least one purchased lottery entry to the beneficiary, at 320. The beneficiary may be phoned, text messaged, paged, mailed, e-mailed, and/or otherwise contacted with information regarding the purchased lottery product. In some embodiments, upon a determining that a beneficiary should receive a lottery entry, a lottery authority, merchant and/or third-party may provide an indication of the lottery entry to the beneficiary. In some embodiments, a recipient, purchaser, or beneficiary may be notified that an expiration condition has been triggered, and may be prompted whether or not they would like to receive an entry into a game of chance.

In some embodiments, an indication of a lottery entry/voucher may be provided to a: (i) beneficiary, purchaser, and/or recipient (e.g., a controller determines that a beneficiary is entitled to twenty dollars ($20) in lottery entries; (ii) party associated with administering an OVA such as: a merchant, a business, a lottery authority, or lottery retailer; (iii) third-party—e.g., a beneficiary may request that his wife be notified via e-mail, for each OVA that becomes expired and redeemed for lottery entries.

An indication of a lottery entry may be provided in a plurality of ways. In one embodiment, a beneficiary may receive an e-mail indicating that one or more lottery tickets have been mailed to a specific address. Redundant forms of notification may help to insure that a higher percentage of beneficiaries actually receive their lottery entries, and thus receive something of value in return for breakage. In one embodiment, an indication of a lottery entry is a redeemable lottery entry itself (as opposed to a voucher or coupon which may require a further redemption process). An indication of a lottery entry/voucher may, in some embodiments, be provided in one or more of the following ways: (i) via telephone—an operator, pre-recorded message, or IVRU may provide an indication of a lottery entry (e.g., a recipient dials a calling card access number, only to find that the remaining balance of the calling card has become expired; an IVRU on the other end of the call provides the recipient with instructions on receiving a lottery ticket in exchange for the expired balance; the instructions include a 6-digit claim number to be entered at a lottery terminal; upon entering the specified claim number, the lottery terminal will print a “live” lottery entry for any redeeming party); (ii) via electronic communication such as e-mail, video messaging, text messaging, and/or instant messaging (e.g., a text message indicating the following may be sent to a beneficiary's mobile phone, “Best Buy card 12301 expired, redeemed $27.05 balance for lottery tickets, expect in mail shortly”); (iii) via a website—e.g., a merchant website that may allow a gift card recipient to check a balance on the gift card may also notify a recipient that one or more lottery entries may be purchased shortly; (iv) via printout—e.g., a lottery voucher number may be printed on the back of a merchant receipt and/or a beneficiary may be able to redeem the lottery voucher at any lottery retailer as long as he provides a valid ID; (v) a terminal display—e.g., a POS terminal at a merchant may indicate to a beneficiary and quantity, type and denomination of lottery entry he will receive; (vi) delivery to an address—e.g., parcel post or UPS delivery with signature confirmation to an address listed by a beneficiary of a lottery entry/voucher; (vii) delivery directly to a beneficiary—e.g., a cashier determines that a beneficiary should receive two (2) ten dollar ($10) lottery entries; and physically provides two (2) five dollar ($5) scratch tickets to the beneficiary; (viii) an indication of a lottery ticket may be provided in the form of a barcode (e.g., in one embodiment, a barcode may be scanned by a lottery retailer in order to determine its authenticity and/or to redeem it); (ix) an indication of a lottery ticket may be provided in the form of a number (e.g., the number may be associated with one or more lottery entries that a beneficiary may be entitled to receive or has already received); (x) in one embodiment, an indication of a lottery voucher may be linked with one or more beneficiaries (e.g., the one or more beneficiaries may be required to produce identification to prove that they are eligible to redeem the lottery voucher and/or a list of eligible voucher redeemers may be stored in an OVA database).

According to some embodiments, an indication of a lottery entry may provide some or all of the following information associated with the lottery entry: (i) an indication of a lottery entry may be an actual lottery ticket such as a “scratch” ticket or “Powerball” ticket. (e.g., printed on cardstock and mailed to the beneficiary as described above); (ii) a serial number or other unique marking that may be used to identify and/or authenticate a lottery entry (e.g. a lottery voucher may contain a unique barcode for scanning at a lottery retailer; the lottery may scan the barcode with a scanner operatively connected to a lottery controller; the lottery controller may cross-reference the barcode with a database of previously-distributed vouchers to determine if the voucher has already been redeemed for a “live” lottery entry; if the voucher is determined to be valid, the lottery retailer may provide a beneficiary with one or more lottery entries); (iii) a name of a beneficiary eligible to redeem a lottery entry; (iv) instructions associated with a lottery entry or other game of chance (e.g., a lottery ticket may include a chart detailing a beneficiary's chances of winning a particular prize, or instructions for redeeming a winning ticket).

According to some embodiments, an indication of a lottery entry may be provided at one or more of the following times: (i) prior to a breakage amount being exchanged for a lottery entry; (ii) during or immediately following a breakage amount being exchanged for a lottery entry (e.g., a mailing, stating that a lottery entry has been purchased for a beneficiary is automatically generated by a lottery authority and sent to the beneficiary; the mailing may contain further instructions on how the beneficiary may redeem a winning outcome; e.g., a beneficiary may receive an email shortly before a lottery drawing, indicating that four lottery entries with different numbers specified by the beneficiary are about to be purchased in the beneficiary's name; the beneficiary may also receive a second email following a drawing, indicating whether or not any of the entries are winning outcomes).

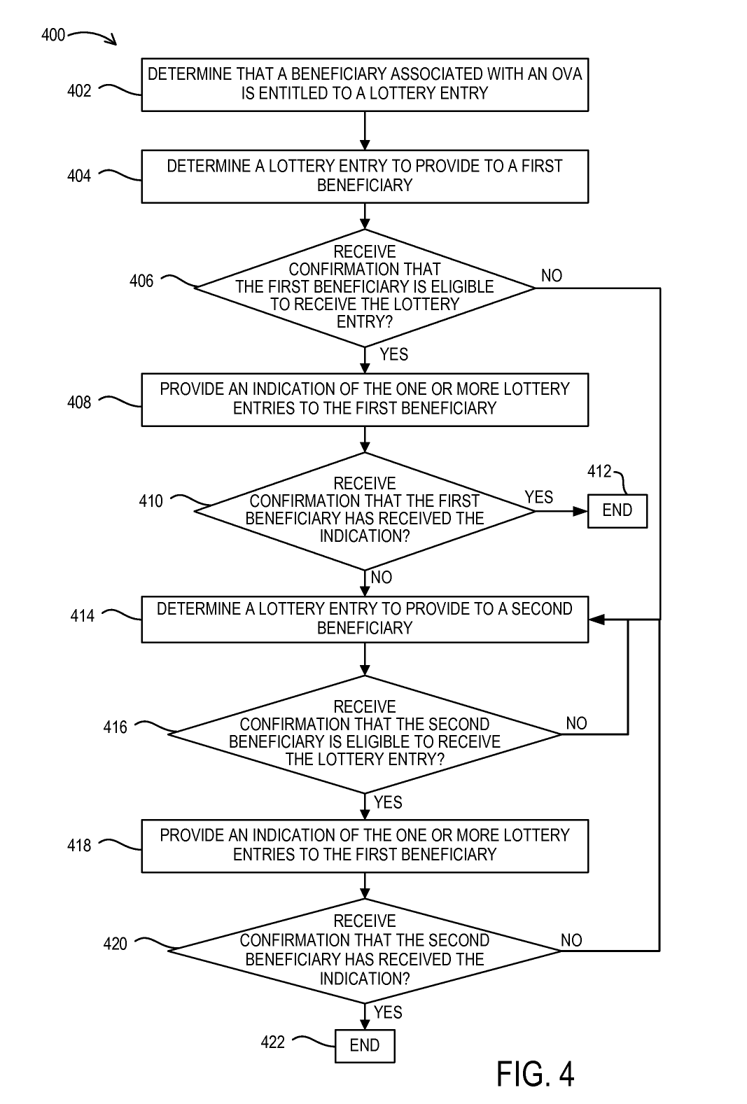

Referring now to FIG. 4, a flow diagram of a method 400 according to some embodiments is shown. In some embodiments, the method 400 may be performed and/or implemented by and/or otherwise associated with the system 100 described in conjunction with FIG. 1. In some embodiments, the method 400 may be associated with and/or comprise the method 200 of FIG. 2, the method 300 of FIG. 3, and/or any portions thereof. According to some embodiments, the method 400 may comprise determining that a first beneficiary associated with an OVA is entitled to a lottery entry, at 402.

The method 400 may also or alternatively comprise determining one or more lottery entries to provide to the first beneficiary, at 404.

The method 400 may also or alternatively comprise determining whether confirmation has been received that the first beneficiary is eligible to receive the lottery entry, at 406. In the case that the determination of the confirmation is positive, the method 400 may continue to 408. In some embodiments, in the case that the determination of the confirmation is negative, the method 400 may continue at 414.

The method 400 may also or alternatively comprise providing an indication of the one or more lottery entries to the first beneficiary, at 408.

The method 400 may also or alternatively comprise determining whether confirmation has been received that the first beneficiary has received the indication (e.g., the indication provided at 408), at 410. In the case that the determination of the confirmation is positive, the method 400 may proceed to end at 412. In some embodiments, in the case that the determination of the confirmation is negative, the method 400 may continue at 414.

The method 400 may also or alternatively comprise determining one or more lottery entries to provide to a second beneficiary, at 414.

The method 400 may also or alternatively comprise determining whether confirmation has been received that the second beneficiary is eligible to receive the lottery entry, at 416. In the case that the determination of the confirmation is positive, the method 400 may continue to 418. In some embodiments, in the case that the determination of the confirmation is negative, the method 400 may loop back to 414 (e.g., where the alternate beneficiary notification process may continue to a third beneficiary, and so on, as needed—in some cases, such as in the case that listed beneficiaries run out, the State may comprise an “nth” and final beneficiary).

The method 400 may also or alternatively comprise providing an indication of the one or more lottery entries to the second beneficiary, at 418.

The method 400 may also or alternatively comprise determining whether confirmation has been received that the second beneficiary has received the indication (e.g., the indication provided at 418), at 420. In the case that the determination of the confirmation is positive, the method 400 may proceed to end at 422. In some embodiments, in the case that the determination of the confirmation is negative, the method 400 may loop back to 414 (e.g., where the alternate beneficiary notification process may continue to a third beneficiary, and so on, as needed—in some cases, such as in the case that listed beneficiaries run out, the State may comprise an “nth” and final beneficiary).

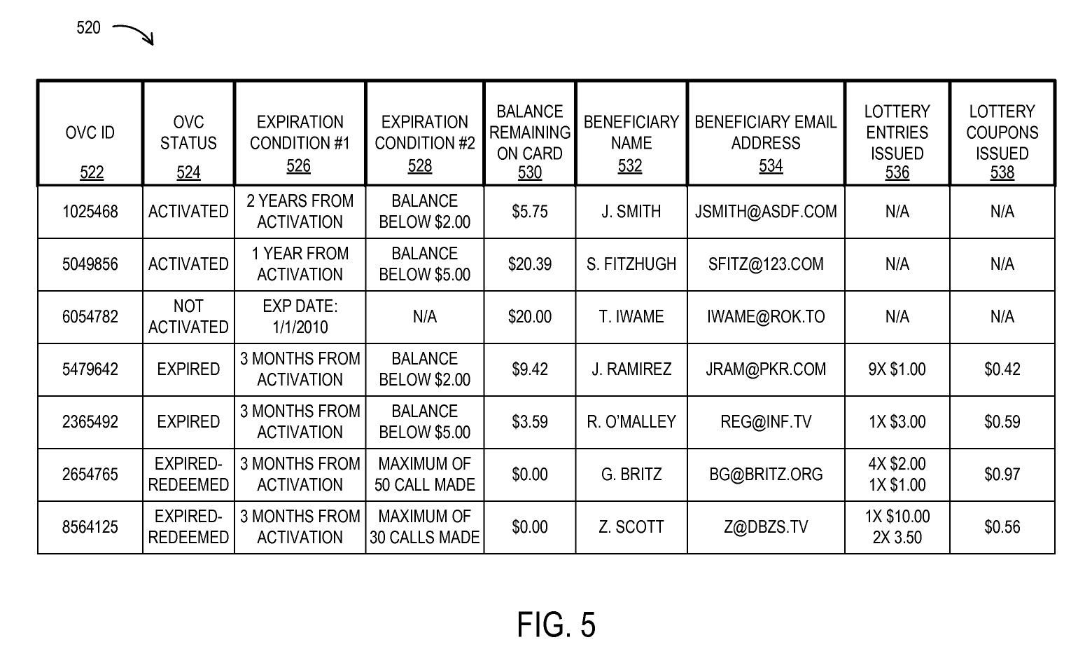

Referring now to FIG. 5, a diagram of a database 520 according to some embodiments is shown. In some embodiments, the database 520 may be similar in configuration and/or content to the database 120 described in conjunction with FIG. 1. The database 520 may, for example, be stored in, coupled to, in communication with, and/or otherwise associated with the terminal 110, the controller 140, the product supply device 150, and/or the value purchaser device 160, all of FIG. 1. The database 520 may also or alternatively be utilized to facilitate and/or implement any or all of the methods 200, 300, 400 of FIG. 2, FIG. 3, and/or FIG. 4, respectively.

According to some embodiments, fewer or more data fields than are shown in FIG. 5 may be associated with the database 520. Only a portion of one or more databases and/or other data stores is necessarily shown in FIG. 5, for example, and other database fields, columns, structures, orientations, quantities, and/or configurations may be utilized without deviating from the scope of some embodiments. Similarly, the data shown in the various data fields is provided solely for exemplary and illustrative purposes and does not limit the scope of embodiments described herein.

According to some embodiments, such as shown in FIG. 5 for example, the database 520 may comprise various data fields such as an OVC ID field 522, an OVC status field 524, and expiration condition #1 field 526, and expiration condition #2 field 528, a balance remaining on card field 530, a beneficiary name field 532, a beneficiary e-mail address field 534, a lottery entries issued field 536, and/or a lottery coupons issued field 538.

### II. AUTOMATIC PRODUCT PURCHASE EMBODIMENTS

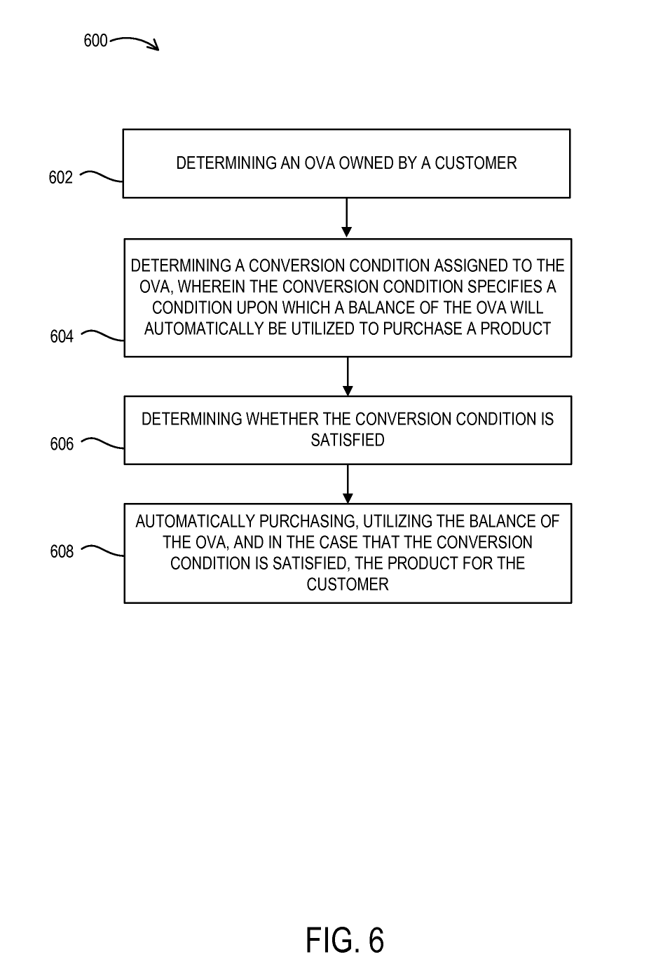

Turning to FIG. 6, a flow diagram of a method 600 according to some embodiments is shown. In some embodiments, the method 600 may be performed and/or implemented by and/or otherwise associated with the system 100 described in conjunction with FIG. 1. In some embodiments, the method 600 may be associated with and/or comprise the method 200 of FIG. 2, the method 300 of FIG. 3, the method 400 of FIG. 4, and/or any portions thereof.

According to some embodiments, the method 600 may comprise determining an OVA owned by a customer, at 602. The information may be found via a database search, for example, and/or in response to receiving an indication of the OVA from the customer (e.g., via a kiosk, website, and/or IVRU)

The method 600 may also or alternatively comprise determining a conversion condition assigned to the OVA, wherein the conversion condition specifies a condition upon which a balance of the OVA will automatically be utilized to purchase a product, at 604. In some embodiments, such a condition may comprise a breakage condition, a simple low balance condition, and/or a simple low use or low use frequency condition.

The method 600 may also or alternatively comprise determining whether the conversion condition is satisfied, at 606. The information determined at 602, for example, may satisfy the conversion condition determined at 604, or it may not. Comparison of quantitative and/or qualitative measures of the information to corresponding measures of the condition may reveal whether there is a match resulting in satisfaction of the condition, or not.

The method 600 may also or alternatively comprise automatically purchasing, utilizing the balance of the pre-paid account, and in the case that the conversion condition is satisfied, the product for the customer, at 608. Various predetermined, randomly selected, and/or customer-selected products and/or services may be automatically purchased on behalf of the customer in the case that the conversion condition is satisfied/met. In some embodiments, such as in the case that the customer has specified a beneficiary for the OVA conversion condition, the product and/or service may be automatically purchased on behalf of and/or provided to the beneficiary (e.g., a friend, relative, and/or charity).

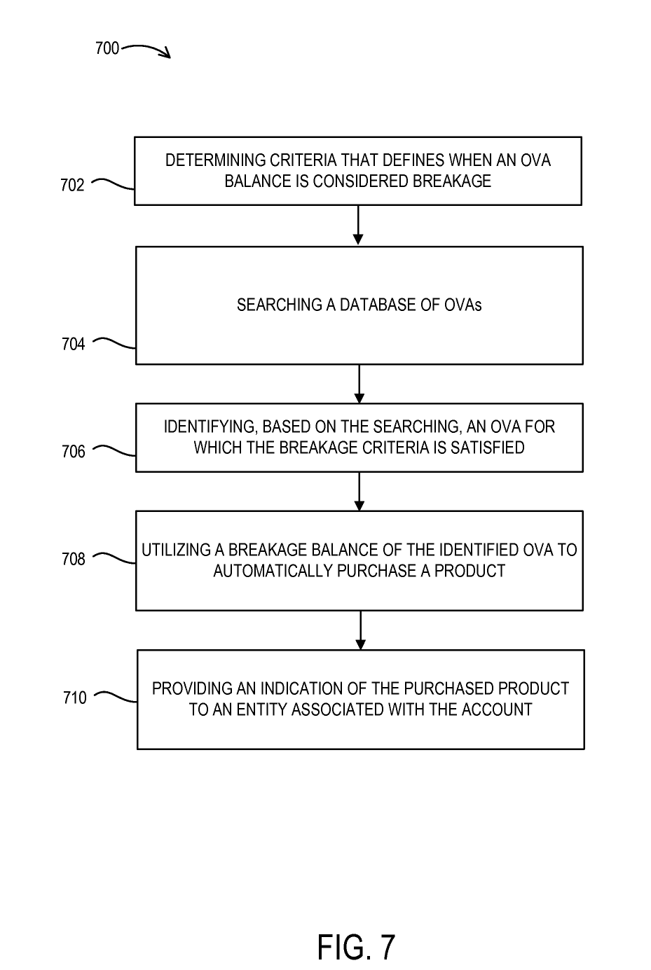

Referring now to FIG. 7, a flow diagram of a method 700 according to some embodiments is shown. In some embodiments, the method 700 may be performed and/or implemented by and/or otherwise associated with the system 100 described in conjunction with FIG. 1. In some embodiments, the method 700 may be associated with and/or comprise the method 200 of FIG. 2, the method 300 of FIG. 3, the method 400 of FIG. 4, the method 600 of FIG. 6, and/or any portions thereof.

According to some embodiments, the method 700 may comprise determining criteria that defines when an OVA balance is considered breakage, at 702.

The method 700 may also or alternatively comprise searching a database of OVAs, at 704.

The method 700 may also or alternatively comprise identifying, based on the searching, an OVA for which the breakage criteria is satisfied, at 706.

The method 700 may also or alternatively comprise utilizing a breakage balance of the identified OVA to automatically purchase a product, at 708.

The method 700 may also or alternatively comprise providing an indication of the purchased product to an entity associated with the OVA, at 710.

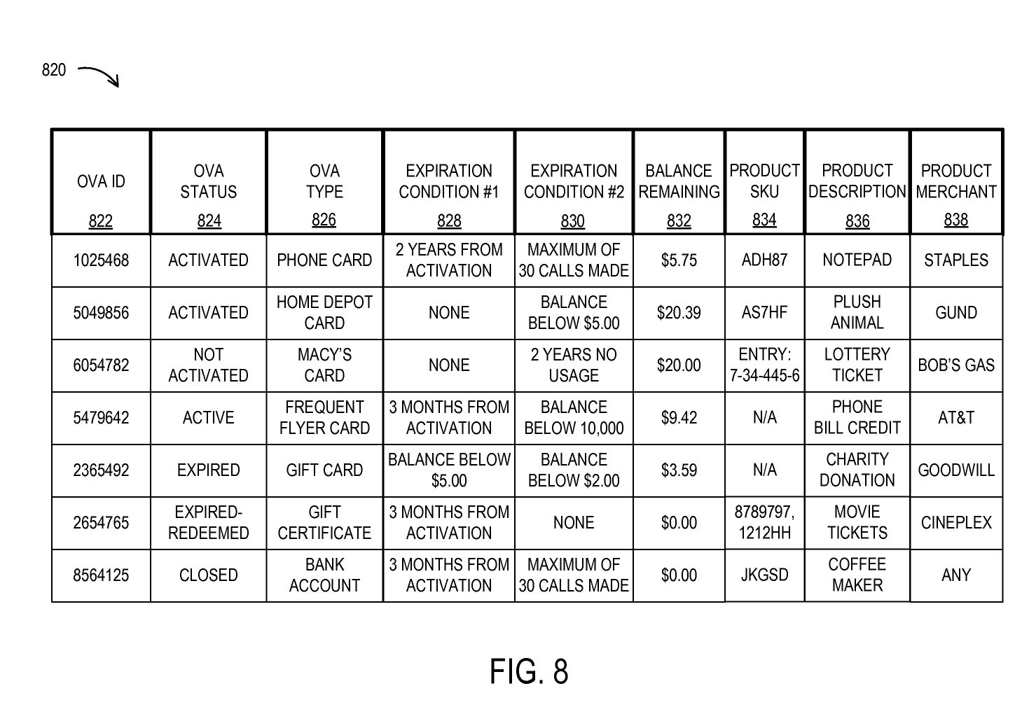

Referring now to FIG. 8, a diagram of a database 820 according to some embodiments is shown. In some embodiments, the database 820 may be similar in configuration and/or content to the databases 120, 520 described in conjunction with FIG. 1 and FIG. 5, respectively. The database 820 may, for example, be stored in, coupled to, in communication with, and/or otherwise associated with the terminal 110, the controller 140, the product supply device 150, and/or the value purchaser device 160, all of FIG. 1. The database 820 may also or alternatively be utilized to facilitate and/or implement any or all of the methods 200, 300, 400, 600, 700 of FIG. 2, FIG. 3, FIG. 4, FIG. 6, and/or FIG. 7, respectively.

According to some embodiments, fewer or more data fields than are shown in FIG. 8 may be associated with the database 820. Only a portion of one or more databases and/or other data stores is necessarily shown in FIG. 8, for example, and other database fields, columns, structures, orientations, quantities, and/or configurations may be utilized without deviating from the scope of some embodiments. Similarly, the data shown in the various data fields is provided solely for exemplary and illustrative purposes and does not limit the scope of embodiments described herein.

According to some embodiments, such as shown in FIG. 8 for example, the database 820 may comprise various data fields such as an OVA ID field 822, an OVA status field 824, and OVA type field 826, an expiration condition #1 field 828, an expiration condition #1 field 830, a balance remaining field 832, a product SKU field 834, a product description field 836, and/or a product merchant field 838.

### Exemplary Owed-Value Card (OVC)

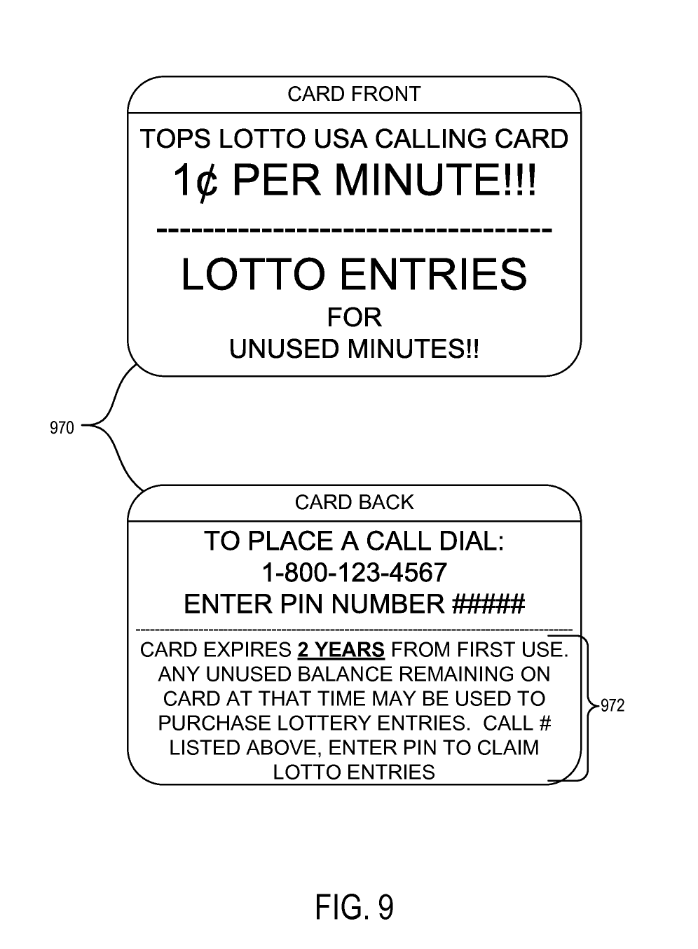

Turning now to FIG. 9, a diagram of an exemplary OVC 970 according to some embodiments is shown. The OVA may, for example, be similar to the OVC 170a-c of FIG. 1 and/or any of the various OVC described herein. In some embodiments, the OVC 970 may comprise a calling card as shown. The OVA 920 may, according to some embodiments, comprise an expiration and/or conversion condition indicia 972. As shown, for example, the calling card OVC 920 will automatically expire two (2) years from the first use, at which point any remaining balance may be utilized to purchase lottery entries.

### Specific Machinery

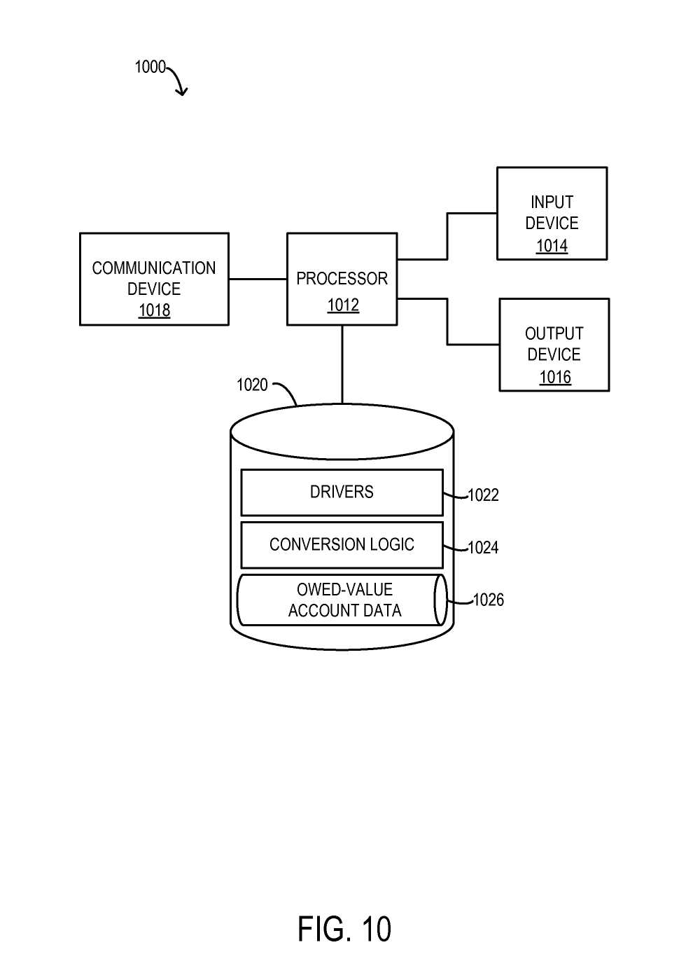

Turning to FIG. 10, a block diagram of a specific machine 1000 according to some embodiments is shown. In some embodiments, the machine 1000 may be similar in configuration and/or functionality to the terminal 110, the controller 140, the product supply device 150, and/or the value purchaser device 160, all as described in conjunction with FIG. 1. The machine 1000 may, for example, be utilized to (i) identify an OVA that qualify for balance conversion into lottery entries and/or other products, (ii) receive an OVC for which a customer desires to convert the balance of into lottery entries and/or other products, (iii) facilitate a purchase and/or auction of OVA balances, and/or (iv) aggregate a plurality of balances from a plurality of OVA into a single OVA and/or OVC. The machine 1000 may also or alternatively execute, process, and/or otherwise be associated with the methods 200, 300, 400, 600, 700 of FIG. 2, FIG. 3, FIG. 4, FIG. 6, and/or FIG. 7, respectively.

In some embodiments, the machine 1000 may comprise a processor 1012, an input device 1014, an output device 1016, a communication device 1018, and/or a data storage device 1020. According to some embodiments, the data storage device 1020 may store drivers 1022, conversion logic 1024, and/or OVA data 1026. In some embodiments, fewer or more components, instructions, and/or data than are shown in FIG. 10 may be included in the machine 1000.

According to some embodiments, the processor 1012 may be or include any type, quantity, and/or configuration of processor that is or becomes known. The processor 1012 may comprise, for example, an Intel® IXP 2800 network processor or an Intel® XEON™ Processor coupled with an Intel® E7501 chipset. In some embodiments, the processor 1012 may comprise multiple inter-connected processors, microprocessors, and/or micro-engines. According to some embodiments, the processor 1012 (and/or the machine 1000 and/or other components thereof) may be supplied power via a power supply (not shown) such as a battery, an Alternating Current (AC) source, a Direct Current (DC) source, an AC/DC adapter, solar cells, and/or an inertial generator. In the case that the machine 1000 comprises a server such as a blade server, necessary power may be supplied via a standard AC outlet, power strip, surge protector, and/or Uninterruptible Power Supply (UPS) device.

In some embodiments, the input device 1014 and/or the output device 1016 may comprise any types or configurations of input and output components and/or devices that are or become known, respectively. The input device 1014 may comprise, for example, a keyboard that allows an operator of the machine 1000 to interface with the machine 1000 (e.g., to program, monitor, and/or initiate OVA conversion sessions and/or activities). In some embodiments, the input device 1014 may comprise a smart card and/or magnetic stripe card reader. The input device 1014 may, for example, allow a customer to swipe and/or insert OVC to provide information such as associated OVA information to the machine 1000 and/or the processor 1012. The output device 1016 may, according to some embodiments, comprise a display screen and/or other practicable output component and/or device. The output device 1016 may, for example, provide feedback to the customer that swipes and/or inserts the OVC via the input device 1014. According to some embodiments, the input device 1014 and/or the output device 1016 may be embodied in a substantially unitary device—e.g., a dual-purpose device such as a touch screen may function as both an input device 1014 and an output device 1016.

In some embodiments, the communication device 1018 may comprise any type or configuration of communication device that is or becomes known or practicable. The communication device 1018 may, for example, comprise a NIC, a telephonic device, a cellular network device, a router, a hub, a modem, and/or a communications port or cable. In some embodiments, the communication device 1018 may be coupled to provide communications access to an IVRU and/or may communicatively couple the machine 1000 to other components operative to facilitate and/or execute the embodiments described herein. According to some embodiments, the communication device 1018 may also or alternatively be coupled to the processor 1012. The communication device 1018 may, for example, comprise an IR, RF, Bluetooth™, and/or Wi-Fi network device coupled to facilitate communications between the processor 1012 and another device.

The data storage device 1020 may, according to some embodiments, store the drivers 1022, conversion logic 1024, and/or OVA data 1026, any or all of which may be utilized by the processor 1012 to provide output information via the output device 1016 and/or the communication device 1018. The data storage device 1020 may comprise any appropriate information storage device that is or becomes known or available, including, but not limited to, units and/or combinations of magnetic storage devices (e.g., a hard disk drive), optical storage devices, and/or semiconductor memory devices such as Random Access Memory (RAM) devices, Read Only Memory (ROM) devices, Single Data Rate Random Access Memory (SDR-RAM), Double Data Rate Random Access Memory (DDR-RAM), and/or Programmable Read Only Memory (PROM). The data storage device 1020 may, in some embodiments, comprise one or more data tables or files, databases, table spaces, registers, and/or other storage structures. In some embodiments, multiple databases and/or storage structures (and/or multiple data storage devices 1020) may be utilized to store information associated with the machine 1000. According to some embodiments, the data storage device 1020 may be incorporated into and/or otherwise coupled to the machine 1000 (e.g., as shown) or may simply be accessible to the machine 1000 (e.g., externally located and/or situated).

According to some embodiments, the drivers 1022 may be operable to cause the processor 1012 to load and/or initialize software and/or firmware and/or otherwise execute stored instruction (e.g., to carry out and/or facilitate embodiments described herein). In some embodiments, the conversion logic 1024 may be operable to cause the processor 1012 to execute and/or otherwise process data in accordance with any or all of the embodiments described herein.

The OVA data 1026 may comprise data associated with one or more OVAs, OVCs, customers, beneficiaries, merchants, purchasers, etc. Such data 1026 may be utilized, for example, in facilitation and/or execution of the embodiments described herein.

### Exemplary System Implementation

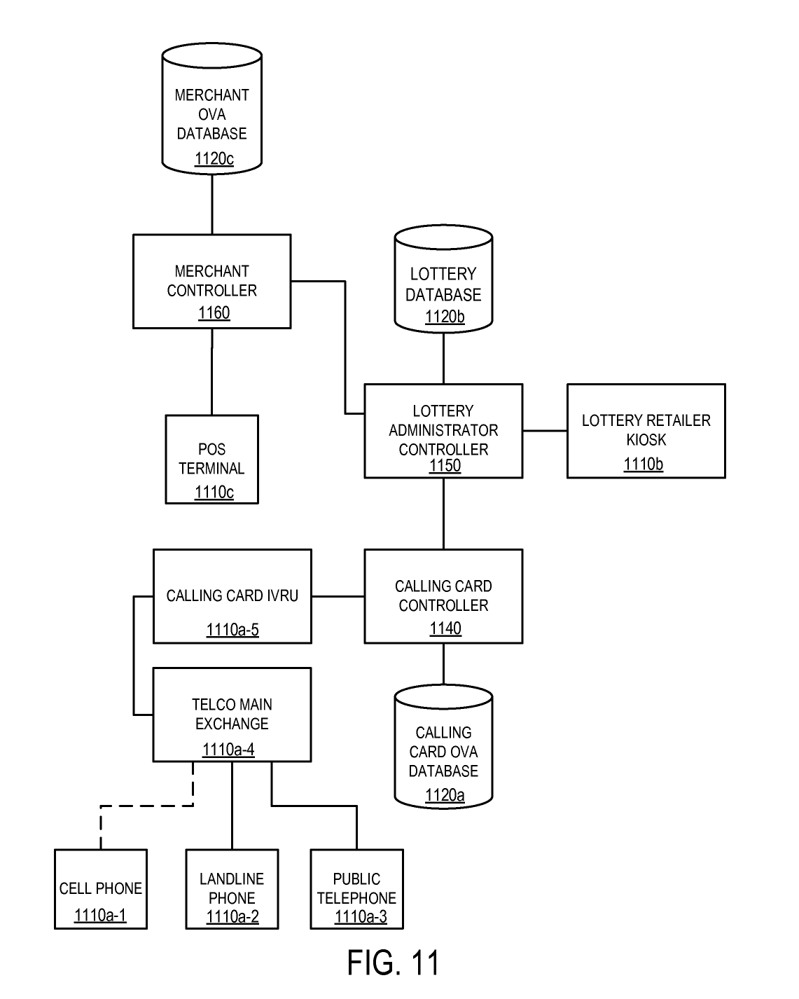

Turning to FIG. 11, a block diagram of a system 1100 according to some embodiments is shown. In some embodiments, the system 1100 may be similar in configuration and/or functionality to the system 100 as described in conjunction with FIG. 1. The system 1100 may, for example, comprise one or more terminals 1110a-c (e.g., one or more customer device terminals 1110a, such as a cell phone 1110a-1, a landline phone 1110a-2, a public telephone 1110a-3, a telco main exchange 1110a-4, and/or a calling card IVRU 1110a-5, one or more kiosks such as a lottery retailer kiosk 1110b, and/or one or more POS terminals 1110c), one or more databases 1120a-c (e.g., a calling card OVA database 1120a, a lottery database 1120b, and/or a merchant OVA database 1120c), a controller such as a calling card controller 1140, a product supply device such as a lottery administration controller 1150, and/or a purchaser device such as a merchant controller 1160. In some embodiments, the system 1100 may execute, facilitate, process, and/or otherwise be associated with the methods 200, 300, 400, 600, 700 of FIG. 2, FIG. 3, FIG. 4, FIG. 6, and/or FIG. 7, respectively.

### EXAMPLES

### Example 1

### Unused Gift Card with Purchaser Benefit

A purchaser buys $100 gift card from a merchant on Jan. 15, 2008. The merchant prints on the gift card in bold, 12 pt font, “Expiration Date: 1/15/2010 (i.e., 2 years from date of purchase). Unused balance on that date will be provided back to original purchaser in form of lottery entries.” The purchaser provides their name and home address (and optionally their email address and phone number) to the merchant during a registration process at a POS terminal.

A controller receives from the merchant's POS terminal: the purchaser's contact information and gift card serial number, and consequently stores it within an OVA database. The purchaser provides the $100 gift card to a recipient. The recipient uses the gift card to pay for a $74.32 purchase, leaving a balance of $25.68 associated with the card.

On Jan. 16, 2010 a controller determines that the remaining balance of $25.68 on the gift card has expired and that the original purchaser should receive a portion of the remaining balance in the form of lottery entries. The controller directs a lottery authority to send the purchaser two $10 lottery entries and a single $0.68 lottery coupon, good for a discount on any lottery ticket purchase. The $25.68 balance is broken up in the following way: (i) the lottery authority receives $20.68 for two $10 lottery entries and a $0.68 lottery coupon; and (ii) the merchant retains $5.00 in breakage, the highest amount allowed by state law.

### Example 2

### Calling Card Breakage Used for Lottery Entries

A purchaser buys for their personal use, a $50 calling card for long-distance calls within the U.S. Since any unused owed-value left on the card may go towards the purchase of a lottery entry, the merchant selling the calling card also verifies that the purchaser is eligible to receive a lottery entry (E.g., age verification).

To initiate a call with the calling card, the purchaser dials a 1-800 access number. Upon first use of the card, a controller operatively connected to a telephone exchange switch, prompts the purchaser to select from the following options: “Press 1 if, when the balance on your calling card drops below $2.00, you would like to use your remaining calling card balance to go towards the purchase of lottery entries. You will not be disconnected if your balance drops below $2 during a phone call; “Press 2 if, after 6 months from first use of your card, you would like to use your remaining balance to go towards the purchase of lottery entries; “Press 3 if you would like one, $1.00 lottery entry purchased with your calling card balance, once-per-month until your balance reaches zero.”

The purchaser selects option 2 which sets an expiration date for his calling card to be 6 months from that day. When the card expires, any balance remaining on the card goes towards the purchase of one or more lottery entries. The purchaser is also prompted for his name and a mailing address where he would like future lottery entries to be mailed. The controller causes the selected option, purchaser contact information, and associated calling card identifier to be stored within an OVA database.

The purchaser follows instructions on the calling card to complete their intended call (e.g., purchaser enters a number they wish to dial along with a PIN code located on the calling card). The purchaser misplaces his calling card after 3 months. The calling card has a remaining balance of $8.45 associated with it at the time. After 6 months from the cards initial use, the controller expires the balance on the calling card, and uses the remaining balance to calculate a value of lottery entries/vouchers to send to the purchaser. The controller directs a lottery authority to mail two $4.00 scratch-it tickets to the purchaser's requested address. The lottery authority receives $7.00 ($3.50 wholesale price for $4.00 cards) in payment in exchange for the “live” scratch-it tickets, while the calling card issuer retains the remaining $1.45 as a processing fee.

### Example 3

### Expiring Airline Miles Converted to Lottery Entries

A frequent flier member of SpeedyJet receives an email stating that he had 7532 miles in his frequent flier account that just expired based on the SpeedyJet's account inactivity policy. The email also states that the member will automatically receive $50 in lottery tickets based the number of miles that expired. If the member would like to choose which lottery tickets he would like to receive, he should follow a highlighted link. Otherwise, a randomly selected $50 worth of lottery tickets will be mailed to his currently listed address.

The member wishes to choose his lottery tickets and clicks on the link to be taken to a SpeedyJet frequent flier login screen. The member logs in with a previously established login/password. A controller determines that the member has followed a link requesting to choose his lottery tickets and that he has successfully logged in. The controller looks up additional information about the member stored within a customer database and determines that the member has been offered to choose $50 in lottery tickets based on his expired 7532 frequent flier miles.

The controller then causes a web page stating the following to be displayed to the member: “Choose any combination of the following lottery tickets up to a total value of $50_$1 Powerball tickets—Randomly generated numbers, click here to designate drawing dates_$1 Pick 6 Lotto tickets—Click here to pick your numbers and designate drawing dates_$1 King of Cash scratch ticket_$5 Trump Card scratch ticket_$10 Jacks are wild scratch ticket”.

The member selects $50 in randomly generated Powerball tickets and designates 10 consecutive drawing dates he would like to play (Five, $1 tickets for each drawing date). The member is then displayed a web page containing his current contact information and is prompted to confirm that the information is correct, including his current mailing address. The member checks his information and determines that all the information is correct. The controller instructs a lottery authority to mail the member his selected lottery tickets prior to the lottery drawings. The lottery authority receives $45 in payment from SpeedyJet to pay for the wholesale cost of $50 in lottery tickets. The remaining $5 is kept by SpeedyJet as a processing fee.

### Additional Embodiments

According to some embodiments, breakage may be pooled from multiple OVAs. In one embodiment, for example, breakage balances may be pooled from one or more OVAs in order to be redeemed for a lottery entry. For example a beneficiary may combine OV from a first gift card and a second gift card into a single breakage balance. The single breakage may be used to purchase one or more lottery vouchers. A lottery authority may administer a program where a beneficiary of one or more OVAs may: associate the one or more OVAs, and eventually use breakage from the OVAs to purchase a lottery entry.

According to some embodiments, breakage may be used to purchase product/services. In one embodiment, a breakage amount may be used to pay for all, or a portion of a product or service. For example, monthly cell phone minutes that have not been used may expire and placed into a breakage account. The breakage account may be used to pay for a new cell phone, or for receiving a discount on a customer's monthly cell phone bill.

According to some embodiments, breakage may be donated to a selected charity. In one embodiment, a purchaser, recipient or beneficiary may specify that breakage associated with an OVA be donated to one or more charitable organizations.

According to some embodiments, proceeds from unredeemed vouchers may be provided back to the merchant. In one embodiment, where a lottery voucher is not redeemed in a timely manner, the proceeds that were used to purchase the voucher may be returned to a merchant or business. For example, a merchant determines that a lottery voucher should be issued to a beneficiary in exchange for a balance on an expired gift card. The merchant uses the expired balance to pay a lottery authority for the voucher and issues the voucher to the beneficiary. The beneficiary receives the voucher but does not bother to redeem it within a two (2) year redemption period. At the end of the two (2) years, the lottery authority returns the expired balance to the merchant. This embodiment may, for example, aid in legalities over a state retaining unclaimed funds without due process and also help merchants be more amiable to handing over a breakage balance

According to some embodiments, an OVC may be used to purchase a lottery entry. In one or more embodiments, an OVC (e.g., calling card, gift card, or gift certificate) may be used to purchase a lottery entry. For example, a recipient of a gift card may be informed that since he has less than five dollars ($5) left on a gift card, he may redeem the remaining balance for one or more lottery entries at any lottery retailer. The recipient swipes the gift card at a lottery terminal of a 7-Eleven® and receives a number of lottery entries equal in value to the remaining balance on the gift card.

Allowing a party to use an OVA to purchase a lottery entry may include modifying the terms of use to the OVA. For example, an OVA may initially be restricted to purchases at Home Depot™. However, upon breakage, a beneficiary may be informed that the terms of the OVA have been modified so that the OVA is now enabled for purchasing lottery tickets at WaWa™ (a local convenience store).

One benefit of this embodiment may be a reduced amount of registration information collected from a beneficiary since the bearer of the card may be considered the beneficiary. Only age verification may be necessary for a beneficiary to exchange a breakage balance for a lottery entry.

According to some embodiments, a beneficiary may convert OV into a lottery entry at anytime. In one embodiment, a beneficiary may opt to exchange all or part of a remaining balance associated with an OVA for one or more lottery entries. For example, a gift card has a remaining balance of twenty-five dollars ($25) on and no triggered expiration conditions associated with it. A beneficiary of the gift card may be allowed to exchange the remaining balance of twenty-five dollars ($25) for one or more lottery entries at any lottery retailer.

### Rules of Interpretation

Numerous embodiments are described in this disclosure, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural, logical, software, and electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

The present disclosure is neither a literal description of all embodiments nor a listing of features of the invention that must be present in all embodiments.

Neither the Title (set forth at the beginning of the first page of this disclosure) nor the Abstract (set forth at the end of this disclosure) is to be taken as limiting in any way as the scope of the disclosed invention(s).

The term “product” means any machine, manufacture and/or composition of matter as contemplated by 35 U.S.C. §101, unless expressly specified otherwise.

The terms “an embodiment”, “embodiment”, “embodiments”, “the embodiment”, “the embodiments”, “one or more embodiments”, “some embodiments”, “one embodiment” and the like mean “one or more (but not all) disclosed embodiments”, unless expressly specified otherwise.

The terms “the invention” and “the present invention” and the like mean “one or more embodiments of the present invention.”

A reference to “another embodiment” in describing an embodiment does not imply that the referenced embodiment is mutually exclusive with another embodiment (e.g., an embodiment described before the referenced embodiment), unless expressly specified otherwise.

The terms “including”, “comprising” and variations thereof mean “including but not limited to”, unless expressly specified otherwise.

The terms “a”, “an” and “the” mean “one or more”, unless expressly specified otherwise.

The term “plurality” means “two or more”, unless expressly specified otherwise.

The term “herein” means “in the present disclosure, including anything which may be incorporated by reference”, unless expressly specified otherwise.

The phrase “at least one of”, when such phrase modifies a plurality of things (such as an enumerated list of things) means any combination of one or more of those things, unless expressly specified otherwise. For example, the phrase at least one of a widget, a car and a wheel means either (i) a widget, (ii) a car, (iii) a wheel, (iv) a widget and a car, (v) a widget and a wheel, (vi) a car and a wheel, or (vii) a widget, a car and a wheel.

The phrase “based on” does not mean “based only on”, unless expressly specified otherwise. In other words, the phrase “based on” describes both “based only on” and “based at least on”.

Where a limitation of a first claim would cover one of a feature as well as more than one of a feature (e.g., a limitation such as “at least one widget” covers one widget as well as more than one widget), and where in a second claim that depends on the first claim, the second claim uses a definite article “the” to refer to the limitation (e.g., “the widget”), this does not imply that the first claim covers only one of the feature, and this does not imply that the second claim covers only one of the feature (e.g., “the widget” can cover both one widget and more than one widget).

Each process (whether called a method, algorithm or otherwise) inherently includes one or more steps, and therefore all references to a “step” or “steps” of a process have an inherent antecedent basis in the mere recitation of the term ‘process’ or a like term. Accordingly, any reference in a claim to a ‘step’ or ‘steps’ of a process has sufficient antecedent basis.

When an ordinal number (such as “first”, “second”, “third” and so on) is used as an adjective before a term, that ordinal number is used (unless expressly specified otherwise) merely to indicate a particular feature, such as to distinguish that particular feature from another feature that is described by the same term or by a similar term. For example, a “first widget” may be so named merely to distinguish it from, e.g., a “second widget”. Thus, the mere usage of the ordinal numbers “first” and “second” before the term “widget” does not indicate any other relationship between the two widgets, and likewise does not indicate any other characteristics of either or both widgets. For example, the mere usage of the ordinal numbers “first” and “second” before the term “widget” (1) does not indicate that either widget comes before or after any other in order or location; (2) does not indicate that either widget occurs or acts before or after any other in time; and (3) does not indicate that either widget ranks above or below any other, as in importance or quality. In addition, the mere usage of ordinal numbers does not define a numerical limit to the features identified with the ordinal numbers. For example, the mere usage of the ordinal numbers “first” and “second” before the term “widget” does not indicate that there must be no more than two widgets. When a single device or article is described herein, more than one device or article (whether or not they cooperate) may alternatively be used in place of the single device or article that is described. Accordingly, the functionality that is described as being possessed by a device may alternatively be possessed by more than one device or article (whether or not they cooperate).

Similarly, where more than one device or article is described herein (whether or not they cooperate), a single device or article may alternatively be used in place of the more than one device or article that is described. For example, a plurality of computer-based devices may be substituted with a single computer-based device. Accordingly, the various functionality that is described as being possessed by more than one device or article may alternatively be possessed by a single device or article.

The functionality and/or the features of a single device that is described may be alternatively embodied by one or more other devices that are described but are not explicitly described as having such functionality and/or features. Thus, other embodiments need not include the described device itself, but rather can include the one or more other devices which would, in those other embodiments, have such functionality/features.

Devices that are in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for weeks at a time. In addition, devices that are in communication with each other may communicate directly or indirectly through one or more intermediaries.

A description of an embodiment with several components or features does not imply that all or even any of such components and/or features are required. On the contrary, a variety of optional components are described to illustrate the wide variety of possible embodiments of the present invention(s). Unless otherwise specified explicitly, no component and/or feature is essential or required.

Further, although process steps, algorithms or the like may be described in a sequential order, such processes may be configured to work in different orders. In other words, any sequence or order of steps that may be explicitly described does not necessarily indicate a requirement that the steps be performed in that order. The steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention, and does not imply that the illustrated process is preferred.

Although a process may be described as including a plurality of steps, that does not indicate that all or even any of the steps are essential or required. Various other embodiments within the scope of the described invention(s) include other processes that omit some or all of the described steps. Unless otherwise specified explicitly, no step is essential or required.

Although a product may be described as including a plurality of components, aspects, qualities, characteristics and/or features, that does not indicate that all of the plurality are essential or required. Various other embodiments within the scope of the described invention(s) include other products that omit some or all of the described plurality.
An enumerated list of items (which may or may not be numbered) does not imply that any or all of the items are mutually exclusive, unless expressly specified otherwise. Likewise, an enumerated list of items (which may or may not be numbered) does not imply that any or all of the items are comprehensive of any category, unless expressly specified otherwise. For example, the enumerated list “a computer, a laptop, a PDA” does not imply that any or all of the three items of that list are mutually exclusive and does not imply that any or all of the three items of that list are comprehensive of any category.

Headings of sections provided in this disclosure are for convenience only, and are not to be taken as limiting the disclosure in any way.

“Determining” something can be performed in a variety of manners and therefore the term “determining” (and like terms) includes calculating, computing, deriving, looking up (e.g., in a table, database or data structure), ascertaining, recognizing, and the like. A “display” as that term is used herein is an area that conveys information to a viewer. The information may be dynamic, in which case, an LCD, LED, CRT, Digital Light Processing (DLP), rear projection, front projection, or the like may be used to form the display. The aspect ratio of the display may be 4:3, 16:9, or the like. Furthermore, the resolution of the display may be any appropriate resolution such as 480i, 480p, 720p, 1080i, 1080p or the like. The format of information sent to the display may be any appropriate format such as Standard Definition TeleVision (SDTV), Enhanced Definition TV (EDTV), High Definition TV (HDTV), or the like. The information may likewise be static, in which case, painted glass may be used to form the display. Note that static information may be presented on a display capable of displaying dynamic information if desired. Some displays may be interactive and may include touch screen features or associated keypads as is well understood.

The present disclosure frequently refers to a “control system”. A control system, as that term is used herein, may be a computer processor coupled with an operating system, device drivers, and appropriate programs (collectively “software”) with instructions to provide the functionality described for the control system. The software is stored in an associated memory device (sometimes referred to as a computer readable medium). While it is contemplated that an appropriately programmed general purpose computer or computing device may be used, it is also contemplated that hard-wired circuitry or custom hardware (e.g., an application specific integrated circuit (ASIC)) may be used in place of, or in combination with, software instructions for implementation of the processes of various embodiments. Thus, embodiments are not limited to any specific combination of hardware and software.

A “processor” means any one or more microprocessors, Central Processing Unit (CPU) devices, computing devices, microcontrollers, digital signal processors, or like devices. Exemplary processors are the INTEL PENTIUM or AMD ATHLON processors. The term “computer-readable medium” refers to any statutory medium that participates in providing data (e.g., instructions) that may be read by a computer, a processor or a like device. Such a medium may take many forms, including but not limited to non-volatile media, volatile media, and specific statutory types of transmission media. Non-volatile media include, for example, optical or magnetic disks and other persistent memory. Volatile media include DRAM, which typically constitutes the main memory. Statutory types of transmission media include coaxial cables, copper wire and fiber optics, including the wires that comprise a system bus coupled to the processor. Common forms of computer-readable media include, for example, a floppy disk, a flexible disk, hard disk, magnetic tape, any other magnetic medium, a CD-ROM, Digital Video Disc (DVD), any other optical medium, punch cards, paper tape, any other physical medium with patterns of holes, a RAM, a PROM, an EPROM, a FLASH-EEPROM, a USB memory stick, a dongle, any other memory chip or cartridge, a carrier wave as described hereinafter, or any other medium from which a computer can read. The terms “computer-readable memory” and/or “tangible media” specifically exclude signals, waves, and wave forms or other intangible media that may nevertheless be readable by a computer.

Various forms of computer readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols. For a more exhaustive list of protocols, the term “network” is defined below and includes many exemplary protocols that are also applicable here.

It will be readily apparent that the various methods and algorithms described herein may be implemented by a control system and/or the instructions of the software may be designed to carry out the processes of the present invention.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models, hierarchical electronic file structures, and/or distributed databases) could be used to store and manipulate the data types described herein. Likewise, object methods or behaviors of a database can be used to implement various processes, such as those described herein. In addition, the databases may, in a known manner, be stored locally or remotely from a device that accesses data in such a database. Furthermore, while unified databases may be contemplated, it is also possible that the databases may be distributed and/or duplicated amongst a variety of devices.

As used herein a “network” is an environment wherein one or more computing devices may communicate with one another. Such devices may communicate directly or indirectly, via a wired or wireless medium such as the Internet, LAN, WAN or Ethernet (or IEEE 802.3), Token Ring, or via any appropriate communications means or combination of communications means. Exemplary protocols include but are not limited to: Bluetooth™, Time Division Multiple Access (TDMA), Code Division Multiple Access (CDMA), Global System for Mobile communications (GSM), Enhanced Data rates for GSM Evolution (EDGE), General Packet Radio Service (GPRS), Wideband CDMA (WCDMA), Advanced Mobile Phone System (AMPS), Digital AMPS (D-AMPS), IEEE 802.11 (WI-FI), IEEE 802.3, SAP, SAS™ by IGT, OASIS™ by Aristocrat Technologies, SDS by Bally Gaming and Systems, ATP, TCP/IP, GDS published by the Gaming Standards Association of Fremont Calif., the best of breed (BOB), system to system (S2S), or the like. Note that if video signals or large files are being sent over the network, a broadband network may be used to alleviate delays associated with the transfer of such large files, however, such is not strictly required. Each of the devices is adapted to communicate on such a communication means. Any number and type of machines may be in communication via the network. Where the network is the Internet, communications over the Internet may be through a website maintained by a computer on a remote server or over an online data network including commercial online service providers, bulletin board systems, and the like. In yet other embodiments, the devices may communicate with one another over RF, cable TV, satellite links, and the like. Where appropriate encryption or other security measures such as logins and passwords may be provided to protect proprietary or confidential information.

Communication among computers and devices may be encrypted to insure privacy and prevent fraud in any of a variety of ways well known in the art. Appropriate cryptographic protocols for bolstering system security are described in Schneier, APPLIED CRYPTOGRAPHY, PROTOCOLS, ALGORITHMS, AND SOURCE CODE IN C, John Wiley & Sons, Inc. 2d ed., 1996, which is incorporated by reference in its entirety.

The term “whereby” is used herein only to precede a clause or other set of words that express only the intended result, objective or consequence of something that is previously and explicitly recited. Thus, when the term “whereby” is used in a claim, the clause or other words that the term “whereby” modifies do not establish specific further limitations of the claim or otherwise restricts the meaning or scope of the claim.

It will be readily apparent that the various methods and algorithms described herein may be implemented by, e.g., appropriately programmed general purpose computers and computing devices. Typically a processor (e.g., one or more microprocessors) will receive instructions from a memory or like device, and execute those instructions, thereby performing one or more processes defined by those instructions. Further, programs that implement such methods and algorithms may be stored and transmitted using a variety of media (e.g., computer readable media) in a number of manners. In some embodiments, hard-wired circuitry or custom hardware may be used in place of, or in combination with, software instructions for implementation of the processes of various embodiments. Thus, embodiments are not limited to any specific combination of hardware and software.

The present disclosure provides, to one of ordinary skill in the art, an enabling description of several embodiments and/or inventions. Some of these embodiments and/or inventions may not be claimed in the present application, but may nevertheless be claimed in one or more continuing applications that claim the benefit of priority of the present application. Applicants intend to file additional applications to pursue patents for subject matter that has been disclosed and enabled but not claimed in the present application.

What is claimed is:

1. A method, comprising:
determining, by a controller device in communication with at least one user device via a network, at least one breakage condition defining when a pre-paid account balance is considered breakage;
identifying, by the controller device and in a database of pre-paid accounts, a first account for which the at least one breakage condition is satisfied, the first account having a first breakage balance;
identifying, by the controller device and in the database of pre-paid accounts, a second account for which the at least one breakage condition is satisfied, the second account having a second breakage balance;
after identifying the first account and identifying the second account, establishing, by the controller device, a third breakage balance based on the first breakage balance of the first account and the second breakage balance of the second account; and
transmitting, by the controller device via a user device, an indication of the third breakage balance to an entity associated with the first account and with the second account.

2. The method of claim 1, wherein at least one breakage condition is based upon a minimum balance threshold of a pre-paid account.

3. The method of claim 1, wherein at least one breakage condition is based upon an amount of time that has elapsed since opening of a pre-paid account.

4. The method of claim 1, wherein at least one breakage condition is based upon an amount of time that has elapsed since expiration of a pre-paid account.

5. The method of claim 1, wherein at least one breakage condition is based upon a number of transactions that have utilized the account.

6. The method of claim 1, further comprising:
utilizing, by the controller device, the third breakage balance to purchase a product automatically; and
transmitting, by the controller device via the user device, an indication of the purchased product to the entity.

7. The method of claim 6, further comprising:
providing the purchased product to the entity.

8. The method of claim 6, further comprising:
determining, by the controller device, the product by retrieving from the database information associated with the first account.

9. The method of claim 6, further comprising:
determining, by the controller device, the product based upon the third breakage balance.

10. The method of claim 1, wherein the third breakage balance comprises a sum of the first breakage balance and the second breakage balance.

11. The method of claim 1, wherein the third breakage balance is less than a sum of the first breakage balance and the second breakage balance.

12. The method of claim 1, wherein establishing the third breakage balance based on the first breakage balance of the first account and the second breakage balance of the second account comprises deducting a fee for pooling the first breakage balance and the second breakage balance.

13. The method of claim 1, wherein the controller device further is in communication with at least one of: (i) a terminal, (ii) a product supply device and (iii) a value purchaser device.

14. An apparatus, comprising:
a processor; and
a storage device in communication with the processor and storing a database of pre-paid accounts, and storing instructions that when executed by the processor result in:
determining at least one breakage condition defining when a pre-paid account balance is considered breakage;
identifying, in the database of pre-paid accounts, a first account for which the at least one breakage condition is satisfied, the first account having a first breakage balance;
identifying, in the database of pre-paid accounts, a second account for which the at least one breakage condition is satisfied, the second account having a second breakage balance;
after identifying the first account and identifying the second account, establishing a third breakage balance based on the first breakage balance of the first account and the second breakage balance of the second account; and
transmitting, via a user device, to an entity associated with the first account and with the second account, an indication of the third breakage balance.

15. The apparatus of claim 14, wherein the instructions when executed by the processor further result in
utilizing the third breakage balance to purchase a product automatically; and
transmitting, via the user device to the entity, an indication of the purchased product.

16. The apparatus of claim 14, wherein the third breakage balance comprises a sum of the first breakage balance and the second breakage balance.

17. The apparatus of claim 14, wherein the third breakage balance is less than a sum of the first breakage balance and the second breakage balance.

18. The apparatus of claim 14, wherein establishing the third breakage balance based on the first breakage balance of the first account and the second breakage balance of the second account comprises deducting a fee for pooling the first breakage balance and the second breakage balance.

19. A memory device storing computer-readable instructions that when executed by a processor result in:
determining, by a controller device in communication with at least one user device via a network, at least one breakage condition defining when a pre-paid account balance is considered breakage;
identifying, by the controller device and in a database of pre-paid accounts, a first account for which the at least one breakage condition is satisfied, the first account having a first breakage balance;
identifying, by the controller device and in the database of pre-paid accounts, a second account for which the at least one breakage condition is satisfied, the second account having a second breakage balance;
after identifying the first account and identifying the second account, establishing, by the controller device, a third breakage balance based on the first breakage balance of the first account and the second breakage balance of the second account; and
transmitting, by the controller device via a user device, an indication of the third breakage balance to an entity associated with the first account and with the second account.
